(19) United States
(12) Patent Application Publication
(10) Pub. No.: US 2023/0186246 A1
(43) Pub. Date: Jun. 15, 2023

(54) Electronic Document Project Assistance Method and System

(71) Applicant: ipQuants AG, Schaffhausen (CH)

(72) Inventors: Tony Afram, Dachsen (CH); Vasileios Vasileiadis, Wadenswil (CH); Ioannis-Anastasios Kourmpetis, Lausanne (CH); Gianluca Tarasconi, Cerano d' Intelvi (IT)

(73) Assignee: ipQuants AG, Schaffhausen (CH)

(21) Appl. No.: 18/165,622

(22) Filed: Feb. 7, 2023

Related U.S. Application Data
(63) Continuation of application No. PCT/EP20/72913, filed on Aug. 14, 2020.

(51) Int. Cl. G06Q 10/10

(52) U.S. Cl. CPC G06Q 10/103

(57) ABSTRACT

A computer-implemented method and system for facilitating processing of project data is provided. An electronic project document is associated with one or more document sources. The one or more content segments are analyzed to identify entities of interest comprised in the one or more content segments. Aggregated information is retrieved from a data source. The aggregated information is associated with one or more of the identified entities of interest and the one or more document sources. In response to receiving the user input selecting at least a first content segment of the one or more content segments, a displayed user interface is modified to display, in a first panel, the selected at least a first content segment and to concurrently display, in a second panel, retrieved aggregated information associated with a first entity of interest comprised in the first selected content segment.

### CROSS-REFERENCE TO RELATED APPLICATIONS

This application is a continuation of PCT International Application No. PCT/EP2020/072913, filed on Aug. 14, 2020.

### FIELD OF THE INVENTION

The present invention relates to an electronic project assistance system for facilitating the processing of project data and a method thereof.

### BACKGROUND

Managing a complex project is part of every knowledge workers work task. From tax lawyers and accountants that must complete e.g. a financial report to M&A lawyers working on a complex merger and/or acquisition project. Not only does each project itself often comprise hundreds of unique project files, such as text files and audio files, a majority of knowledge workers are participating on multiple of such projects at once.

An intellectual property counsel may for example work on patent litigation in one jurisdiction, on a trademark litigation case in another jurisdiction, while at the same time being directly and/or indirectly responsible for hundreds of patent applications before the European Patent Office (EPO), the US Patent and trademark office (USPTO) etc.

To be able to manage the document flow from the counterparties, such as patent offices, opponents, clients and the like, law firms use project management systems. These are well known in the art and offered by dedicated software providers that focus on the legal document software. Such project management systems, generally also referred to as docketing systems in the legal profession, allow the user to store project-related information in one location. These project management (PM) systems are maintained by one or more employees to keep them up-to date, usually by paralegals in a law-firm environment. Due to the volume of correspondence received by, for example, a law firm it is a frustrating and costly experience to keep the PM system up to date. It is not only costly from the point of view of employee hours invested to maintain the system, but also requires dedicated technical resources to maintain a satisfactory performance of the PM systems. Speed in retrieving the relevant documents depends on the computer system specification and data storage approach chosen.

For the project owner, it is challenging to select the right project to focus on under present time constraints and furthermore difficult to allocate the right resources to each project. The resources are not only human resources, such as who in addition to the project owner needs to support the project owner to complete the project, but certain projects require also usage of technical tools which might have technical constraints, such as how many users can use the tools at once. Thus, in an unfortunate situation, the project owner might not be able to use the required technical resources to complete the task. This will inevitably lead to poor quality of the project work product.

Moreover, the PM system usually includes all the project related due dates and at least all relevant project files in the system accessible by a project owner user via dedicated computer software applications either locally installed and/or via a web-browser. To manage the projects and associated project tasks associated with the project owner, other project owners, such as a paralegal, will keep the to-do tasks list up to date and will prioritize by due date and give the project owner required reminders.

Once the project owner receives the next project in the queue, the project owner will start with the workflow in reviewing each document and then completing the associated tasks. Especially in the field of law this can be a very time consuming, resource-intensive phase, since multiple complex documents must be reviewed before the attorney can arrive at a conclusion. This frequently requires the project owner to having to complete a project under significant time pressure.

The complexity of the project having an open task, is not just regarding the length of one document that the project owner must review. The document, such as an Official Communication from the patent office, includes several references to other cited documents, which forces the user—in this example the patent attorney—to not only jump between different sections of one and the same document, but also jump between different complex documents.

In view of the above, the workflow of the user is very inefficient and even approaches of using multiple screens have not been able to resolve this problem satisfactorily. These types of professionals are therefore still mainly printing out the relevant documents in order to accomplish the task. A paralegal will also maintain a physical paper file which then requires routing also the paper file to the responsible project owner. This brings negative environmental effects due to the paper consumption, wear of the printer, electricity consumption and toner consumption. It furthermore also poses a logistical problem to route physical files in time to the relevant project participants.

### SUMMARY

It is an object of the present invention to provide an electronic project assistance system and method that overcomes the drawbacks of the known methods and systems and which allows a cost-efficient and resource-efficient completion of a project along with improved project work product quality.

According to an aspect of the present invention, there is provided a computer-implemented method of facilitating processing of project data. The method may comprise: receiving an electronic project document comprising one or more content segments, wherein the electronic project document is associated with one or more document sources; analyzing the one or more content segments to identify entities of interest comprised in the one or more content segments; retrieving, from a data source, aggregated information associated with one or more of the identified entities of interest and the one or more document sources; receiving a user input selecting at least a first content segment of the one or more content segments; and in response to receiving the user input, modifying a displayed user interface to display, in a first panel, the selected first content segment and to concurrently display, in a second panel, retrieved aggregated information associated with at least a first entity of interest comprised in the selected first content segment.

By modifying the displayed user interface in response to the user input, the user is provided with a graphical shortcut allowing the user to directly retrieve aggregated information without the need for the user to understand the predetermined protocols of the system, such as programming language and how the aggregated data is stored in the data source.

Displaying the user interface may further comprise displaying, in a third panel, at least one content segment of another electronic project document associated with the first entity of interest and associated with at least one document source of the one or more document sources.

Displaying, in the second panel, the retrieved aggregated information may comprise displaying an indication of a current state of a project associated with the electronic project document with respect to the first entity of interest comprised in the selected first content segment and an indication of at least one predicted future state of the project with respect to the first entity of interest comprised in the selected first content segment. The indication of the at least one predicted future state of the project may be based on analysis of other electronic project documents associated with a document source of the one or more document sources.

Displaying, in the second panel, the retrieved aggregated information may comprise displaying a timeline user interface element. The timeline user interface element may display the indication of the current state of the project and the indication of at least one predicted future state of the project in a chronological order. The electronic project document may be associated with a patent application and the first entity of interest is an objection. The at least one predicted future state of the project may correspond to a project rejection score, the project rejection score being associated with a likelihood of obtaining a patent. If the project rejection score is above a predetermined threshold value, a graphical risk warning icon may be displayed in the user interface.

The retrieved aggregated information may be displayed in the second panel is associated with the first entity of interest and a first one of the one or more document sources. In response to receiving a user input, the displayed user interface may be modified to display, in the second panel, the retrieved aggregated information associated with the first entity of interest and a second one of the one or more document sources.

The analyzing the one or more content segments to identify entities of interest comprised in the one or more content segments may be performed in response to receiving the user input selecting the first content segment of the one or more content segments.

The user is therefore provided with a continued and guided human-machine interaction process assisting the user in analyzing the project data. Furthermore, the user may advantageously input commands for the processing of data without the requirement of prior knowledge of the language or protocols used by the system or how the data is stored in the database.

The analyzing of the one or more content segments to identify entities of interest comprised in the one or more content segments may be performed in response to receiving the electronic project document.

The method may further comprise processing the identified entities of interest to generate the aggregated information; and storing the identified entities of interest and the aggregated information in one or more data sources.

The one or more document sources may comprise a project participant and a group of individuals comprising the project participant. The project participant may be an author of the electronic project document or a recipient of the electronic project document.

The identified entities of interest may comprise one or more of a name of a project participant, a name of a project, a name of a product, a reference to a technical concept, a reference to a legal concept, a reference to a legal article, an objection, a reference to a document and a reference to a case law decision. The aggregated information may comprise at least one of statistical data, performance metrics, trend data and multiple documents.

The method may further comprise: in response to receiving a selection of at least one of the first panel and the second panel, generating a collaboration project space comprising the selected at least one panel; identifying at least one collaborator based on the retrieved aggregated information associated with at least one entity of interest corresponding to the first selected content segment, wherein the at least one collaborator is, prior to the selection, not a project participant; and providing the at least one collaborator with access to the collaboration project space.

The method may further comprise: determining a project complexity score based on one or more of a type of the identified entities of interest, a status of the identified entities of interest, the one or more document sources and the retrieved aggregated information.

The method may further comprise, if the project complexity score is above a predetermined threshold value, displaying, in the user interface, a graphical warning icon.

The electronic project document may be associated with a patent application and the first entity of interest comprised in the first selected content segment is an objection, and the method may further comprise: determining a type of the objection; determining a status of the objection, wherein the status is one of new, maintained, overcome and other; and determining an objection intensity score for the objection based at least in part on the determined type and/or the determined status.

The method may further comprise, if the objection intensity score is above a predetermined threshold value, displaying, in the user interface, a graphical warning icon.

The user interface may be further configured to display a list of projects, wherein the list of projects includes a project associated with the electronic project document, and wherein an order of the projects in the list of projects is based at least in part on an upcoming due date associated with each of the projects in the list of projects and at least one of the project complexity score and the objection intensity score.

The user is therefore provided with a continued and guided human-machine interaction process assisting the user in prioritizing tasks necessary for the running of the project.

The method may further comprise in response to detecting a user interaction with the first panel, modifying the displayed user interface to display, in the first panel, the first entity of interest comprised in the selected first content segment and a second entity of interest comprised in the selected first content segment, and to concurrently display, in the second panel, retrieved aggregated information associated with both the first entity of interest and the second entity of interest.

The method may further comprise: receiving a user input selecting a second content segment of the one or more content segments; and in response to receiving the user input, modifying the displayed user interface to display, in the first panel, the selected first content segment and the selected second content segment, and to concurrently display, in the second panel, retrieved aggregated information associated with both the first entity of interest comprised in the selected first selected content segment and a first entity of interest comprised in the selected second content segment.

The method may further comprise at least one of: modifying the indication of the current state of the project to display an indication of the current state of the project with respect to both the first entity of interest comprised in the selected first content segment and a first entity of interest comprised in a selected second content segment, and modifying the indication of the at least one predicted future state of the project to display the at least one predicted future state of the project with respect to both the first entity of interest comprised in the first selected content segment and the first entity of interest comprised in the selected second content segment.

The at least one of modifying the indication of the current state of the project and modifying the indication of the at least one predicted future state of the project may be performed in response to receiving a user input selecting the second content segment.

According to an aspect, there is provided a computer-readable storage medium having computer-executable instructions stored thereon which, when executed by the processor, perform the method above.

According to an aspect, a computing system for facilitating processing of project data is provided. The computing system may comprise: a display device configured to display a user interface; a processor; and a memory having computer-executable instructions stored thereon which, when executed by the processor, may cause the computing display system to perform operations comprising: display an electronic project document comprising one or more content segments, wherein the electronic project document is associated with one or more document sources; in response to receiving user input selecting at least a first content segment of the one or more content segments, display a first user interface panel comprising the selected first content segment and concurrently display a second user interface panel comprising representations of retrieved aggregated information associated with the one or more document sources and at least a first entity of interest comprised in the selected first content segment.

The operations may further comprise: in response to receiving the user input selecting the at least first content segment of the one or more content segments, displaying a third user interface panel comprising at least one content segment of another electronic project document associated with the first entity of interest and associated with a document source of the one or more document sources.

Displaying the second user interface panel may comprise displaying an indication of a current state of a project associated with the electronic project document with respect to the first entity of interest and an indication of at least one predicted future state of the project with respect to the first entity of interest. The indication of the at least one predicted future state of the project is based on analysis of other electronic project documents associated with at least one document source of the one or more document sources.

Displaying, in the second user interface panel, the retrieved aggregated information corresponding to the selected first content segment may further comprise displaying a timeline user interface element. The timeline user interface element may display the indication of the current state of the project and the indication of the at least one predicted future state of the project in a chronological order.

The electronic project document may be associated with a patent application and the first entity of interest is an objection. The at least one predicted future state of the project may correspond to a project rejection score, the project rejection score being associated with a likelihood of obtaining a patent. If the project rejection score is above a predetermined threshold value, the operations may further comprise displaying, in the user interface, a graphical risk warning icon.

The retrieved aggregated information comprised in the second user interface panel may be associated with the first entity of interest and a first one of the one or more document sources. The operations may further comprise, in response to receiving a user input, modifying the displayed user interface panel to comprise the retrieved aggregated information associated with the first entity of interest and a second one of the one or more document sources.

The operations may further comprise: in response to receiving the user input selecting the first content segment, analyzing the first content segment to identify entities of interest comprised in the first content segment. The operations may further comprise: in response to receiving the electronic project document, analyzing the one or more content segments to identify entities of interest comprised in the one or more content segments.

The operations may further comprise: processing the identified entities of interest to generate the aggregated information; and storing the one or more identified entities of interest and the aggregated information in one or more data sources.

The one or more document sources may comprise a project participant and a group of individuals comprising the project participant. The project participant may be an author of the electronic project document or a recipient of the electronic project document.

The identified entities of interest may comprise one or more of a name of a project participant, a name of a project, a name of a product, a reference to a technical concept, a reference to a legal concept, a reference to legal article, an objection, a reference to a document and a reference to a case law decision.

The aggregated information may comprise at least one of statistical data, performance metrics, trend data and multiple documents.

The operations may further comprise: in response to receiving a selection of at least one of the first user interface panel and the second user interface panel, displaying a collaboration project space comprising the selected at least one panel; identifying at least one collaborator based on the retrieved aggregated information, wherein the at least one collaborator is, prior to the selection, not a project participant; and providing the at least one collaborator with access to the collaboration project space.

The operations may further comprise: determining a project complexity score based on one or more of a type of the identified entities of interest, a status of the identified entities of interest, the document source and the retrieved aggregated information.

The operations may further comprise: if the project complexity score is above a predetermined threshold value, displaying, in the user interface, a graphical warning icon.

The electronic project document may be associated with a patent application and the first entity of interest is an objection. The operations may further comprise: determining a type of the objection; determining a status of the objection, wherein the status is one of new, maintained, overcome and other; and determining an objection intensity score for the objection based at least in part on the determined type and/or the determined status.

The operations may further comprise: if the objection intensity score is above a predetermined threshold value, displaying, in the user interface, a graphical warning icon.

The operations may further comprise: displaying a fourth user interface panel comprising a list of projects, wherein the list of projects includes a project associated with the at least one electronic project document, and wherein an order of the projects in the list of projects is based at least in part on an upcoming due date associated with each of the projects in the list of projects and at least one of the project complexity score and the objection intensity score.

The operations may further comprise: in response to detecting a user interaction with the first user interface panel, modifying the displayed first user interface panel to display the first entity of interest and a second entity of interest comprised in the first selected content segment, and the second user interface panel to concurrently display retrieved aggregated information associated with both the first entity of interest and the second entity of interest.

The operations may further comprise: receiving a user input selecting a second content segment of the one or more content segments; and in response to receiving the user input, modifying the displayed first user interface panel to display the selected content segment and modifying the displayed second user interface panel to display representations of retrieved aggregated information associated with the one or more document sources and a first entity of interest comprised in the selected second content segment.

The operations may further comprise: receiving a user input selecting at least a second content segment of the one or more content segments; in response to receiving the user input, modifying the displayed first user interface panel to display the selected first content segment and the selected second content segment; and modifying the displayed second user interface panel to display representations of retrieved aggregated information associated with one or more document sources, the first entity of interest comprised in the first selected content segment, and a first entity of interest comprised in the second selected content segment.

Displaying the modified second user interface panel may comprise displaying one or more of: an indication of the current state of the project with respect to both the first entity of interest comprised in the selected first content segment and the first entity of interest comprised in the selected second content segment and an indication of at least one predicted future state of the project with respect to both the first entity of interest comprised in the selected first content segment and the first entity of interest comprised in the selected second content segment.

### DEFINITIONS

A project is a planned undertaking engaged in by one or more project participants to meet a specific goal. As used herein, the term “electronic project” is used to refer to a collection of electronic files, each associated with one or more interrelated tasks that are planned for completion over a fixed period of time and within certain requirements and limitations such as cost, quality, performance etc.

As used herein, the term “electronic project file” encompasses any type of electronic document data format, including but not limited to word processing documents, spreadsheets, presentations, images, maps, emails, websites etc. An electronic project document is one type of an electronic project file. Typical examples of electronic document data formats include Adobe PDF® documents, Microsoft WORD® documents, website in HTML or the like. Further, the electronic project files may be any known structured or unstructured data file, such as XML, HTML, CSV, PDF®, WORD®, JSON and the like.

Electronic project documents associated with a project are usually documents with many pages, also referred to as “long documents”. For example, an electronic project document may be a report, a patent application, an official communication or office action from the respective patent office, or prior art documents. Some long documents might not have several distinct pages, such as a website or Wikipedia page. Such long documents are nevertheless still considered as long documents in the sense that the user must scroll through many lines of text and/or media content (images, video, etc.) to review the entire document. Thus, in common for all “long documents” is the fact that the entire content of the document cannot be shown at once in a readable manner in a document display window of the digital project assistance system. The user must scroll (browse) through the document in order to review the entire content thereof.

Other types of electronic project files are image files, digital audio files and video files. Image, audio and/or video files can additionally be embedded in electronic project documents.

Each electronic project file is associated with at least one document source. As used herein, the term “document source” corresponds to the origin and/or destination of the electronic project file. A document source may be a project participant, such as the author/creator of the electronic project file, the recipient of the document etc. A document source may additionally or alternatively be a company or an organization from which the document originated or to which the document was sent. A document source may be any individual, group of individuals, company or organization associated with the project. For example, if the project relates to a patent application, document sources may include the respective patent office, a patent office individual (e.g., an examiner, Board of Appeal member, opposition division member etc.) or a patent office division (i.e., a group of patent office individuals, such as an examining division, an opposition division, an appeal division etc.), the applicant (a legal or natural person, e.g. a company, organization or individual), the inventor, the respective patent attorney/agent assigned to the project and so on. Here, the respective patent office, the patent office individual, the patent office division, the inventor and the respective patent attorney/agent assigned to the project are authors or recipients of the electronic file. Accordingly, an electronic project file may be associated with multiple document sources. For example, an individual (such as an Examiner) who is the author of the document, the team (i.e. group of individuals such as the Examining Division) within which the author works, and the company/organization (such as the EPO) where the individual works.

Each electronic project file comprises one or more entities of interest. As used herein the term “entity of interest” is a predetermined portion of content corresponding to an entity used to generate and display aggregated information associated with the electronic project file as described in detail below. When the content is written content, an entity of interest may be a predefined pattern of characters such as a predefined word, phrase or expression. For example, an entity of interest may be a name of a project participant, a project, a product, a technical concept and so on. In the example where the electronic project relates to a patent application, an entity of interest may be a reference to a legal article of the EPC, reference to an objection, reference to a case law decision, reference to a legal topic (such as ex post fact analysis, undue burden and so on), reference to a technical concept, reference to an Examiner name, Examining Division, Opposition Division (OD) or OD member name, Board of Appeal (BoA) or BoA member name, Patent applicant, Patent Applicant Agent, Opponent, Opponent Agent and the like. When the content is an image or video content, an entity of interest may be a predetermined pattern of pixels corresponding to a face or object appearing in the image or in a video frame. When the content is audio content, the entity of interest may be a predetermined pattern of audio signals corresponding to a predetermined spoken word, phrase, sound and so on. An entity of interest may additionally be an entity associated with a predefined pattern of characters, pixels or audio signals. For example, the name of a project participant may not be explicitly included in an electronic project file, but a specific expression/phrase or an image comprising a signature that corresponds to the name of the project participant may be present in the document.

As used herein, the term “objection” refers to a statement of opposition to an aspect of a judicial or other legal proceeding. Specifically, in the following, examples of an electronic project assistance system will be described regarding a European Patent Application project. A patent application submitted with the patent office, such as the European Patent Office (EPO), is examined by the European Patent Office before a decision to grant or a decision to reject the request for grant of a patent is taken by the Examining Division. The EPO is one counterparty to the project owner, here the patent attorney representing a patent applicant. Especially, the EPO counterparty can be any Examining Division Member, Opposition Division Member and/or Board of Appeal member. Another counterparty can be one or more opponents of the applicant and/or the opponents patent attorney. A further counterparty can be one or more members of the same organization of the project owner. Thus, in this context, an objection refers to a statement of opposition to an aspect of the patent application, usually raised by an Examiner or an opponent. The project owner in this example is the patent attorney representing the patent applicant. However, the patent applicant could have their own electronic project assistance system and from their point of view be the project owner for the project lead within the patent applicant organization. The below examples will focus on the project owner being the patent attorney who is part of a law firm, but could equally have been a patent attorney of an in-house IP department.

It is to be understood, however, that the specific examples provided herein with regard to a European patent application are also applicable to other legal jurisdictions and to other business fields and industries. For example, references to concepts specific to European patent law such as the “EPC”, “objections”, “Examining Division”, “Opposition Division”, “Board of Appeal”, “Examination Guidelines” etc. are to be understood by their equivalents in other patent law jurisdictions, such as at the LISPTO, WIPO and SIPO. In this regard, referring to the LISPTO, the term “objection” is to be understood as being synonymous with “rejection”, references to the European Patent Convention (EPC) are to be understood as meaning references to the United States Code (USC) and references to the Examination Guidelines (GL) are to be understood as meaning references to the Manual of Patent Examination Procedure.

### BRIEF DESCRIPTION OF THE DRAWINGS

The accompanying drawings are incorporated into and form a part of the specification for the purpose of explaining the principles of the embodiments. The drawings are not to be construed as limiting the embodiments to only the illustrated and described embodiments of how they can be made and used. Further features and advantages will become apparent from the following and more particularly from the description of the embodiments, as illustrated in the accompanying drawings, wherein:

FIG. 1 is a schematic representation of a computer-implemented system for processing project data;

FIG. 2 is a schematic representation of a user interface for displaying a list of projects that may be viewed and interacted with through the system;

FIG. 3 is a schematic representation of a user interface for displaying a list of project files.

FIG. 4 is a schematic representation of an electronic project document.

FIG. 5 is a schematic representation of a user interface for displaying an electronic project document.

FIG. 6 is a schematic representation of a user interface for displaying a project main page.

FIG. 7 is a schematic representation of a user interface for displaying project sub-page.

FIG. 8 is a schematic representation of a user interface for displaying aggregated information relating to a selected project.

FIG. 9 is another schematic representation of a user interface for displaying aggregated information relating to a selected project.

FIG. 10A is another schematic representation of a user interface for displaying aggregated information relating to a selected project.

FIG. 10B is another schematic representation of a user interface for displaying aggregated information relating to a selected project.

FIG. 10C is another schematic representation of a user interface for displaying aggregated information relating to a selected project.

FIG. 11 is another schematic representation of a user interface for displaying aggregated information relating to a selected project.

FIG. 12 is a schematic representation of a user interface for sharing project information.

FIG. 13 is a flow diagram showing a method for processing project data.

### DETAILED DESCRIPTION OF THE EMBODIMENTS

For purposes of explanation, numerous examples and specific details are set forth in order to provide a thorough understanding of the described embodiments. Embodiments as defined by the claims may include some or all of the features in these examples alone or in combination with other features described below, and may further include modifications and equivalents of the features and concepts described herein. The illustrative embodiments will be described with reference to the drawings wherein like elements and structures are indicated by like reference numbers. Further, where an embodiment is a method, steps and elements of the method may be combinable in parallel or sequential execution. As far as they are not contradictory, all embodiments described below can be combined with each other.

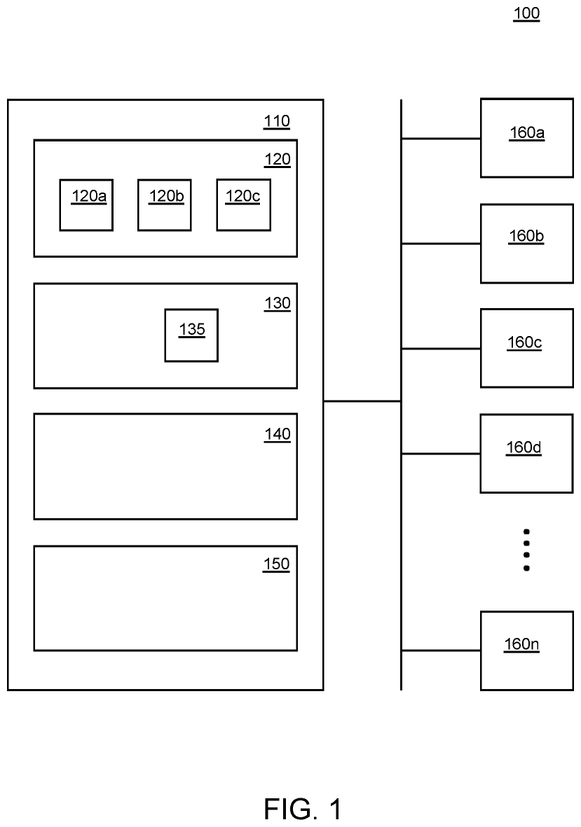

FIG. 1 illustrates a system 100 for facilitating the processing of project data in accordance with an embodiment. The system 100 includes an electronic project assistance system 110 and one or more data sources 160. The electronic project assistance system 110 is configured to manage multiple digital projects and associated electronic project files.

As illustrated in FIG. 1, the electronic project assistance system 110 comprises at least one data insights module 120, a project workflow module 130, a display module 140 and a project sharing module 150. The data insights module 120, the project workflow module 130, the display module 140 and the project sharing module 150 can execute their respective services by implementing such services as software in physical hardware on one or more servers or in other manners known to the skilled person. The modules 120, 130, 140 and 150 are configured to communicate with each other in any suitable known manner. In addition, the data insights module 120, the project workflow module 130, the display module 140 and the project sharing module 150 may access the one or more data sources 160 in order to complete their respective services in any known manner, such as for example via an API (application programming interface).

Each project might include several hundred or more electronic project files. The one or more electronic project files may be stored by the one or more data sources 160. Each electronic project file is associated with at least one document source. A document source may be a project participant, such as the author of the document, the recipient of the document etc. A document source may additionally or alternatively be a company or organization from which the document originated or to which the document was sent. A document source may be any individual, company or organization associated with the project. For example, if the project relates to a patent application, document sources may include the respective patent office, a patent office individual (examiner, appeal member or opposition member) or a patent office division (examining division, opposition division or appeal division) , the applicant (a company, organization or individual), the inventor, the respective patent attorney/agent assigned to the project and so on.

A user may view and interact with the electronic project assistance system 110 via a user interface generated by the display module 140. The user interface may be displayed to a user on the user's respective user device (not shown). The user device may be any suitable computing device having a display. The user interface may be rendered in any suitable manner, such as in a known browser window, by application software or another computer program.

The display module 140 is configured to communicate with the data insights module 120, the project workflow module 130 and the project sharing module 150 and to access one or more of the data sources 160 to generate the user interface. The display module 140 is configured to generate and modify the user interface based on user input and/or instructions received from modules 120, 130 and 140. The display module 140 is further configured to communicate with the user device for displaying the user interface.

The project workflow module 130 is configured to initiate a workflow that sends instructions to the one or more data sources 160 and data insights module 120 to receive input regarding each identified entity of interest along with the location of each of the identified entities of interest within the electronic project document. Based on the entities of interest including objection location information and other aggregated information received from the one or more data sources 160 and the data insight module 120, the workflow module is further configured to instruct the display module to display the information in a user interface.

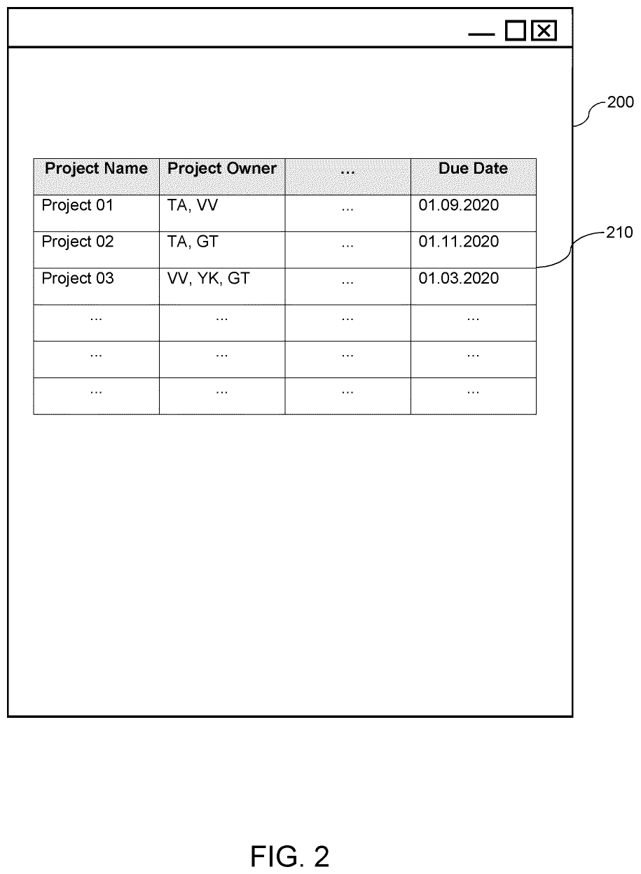

FIG. 2 illustrates an example of a user interface 200 displaying information relating to the projects that may be viewed and interacted with through the electronic project assistance system 110. The user interface displays a project table 210 comprising a list of projects. Each entry in the list comprises, for example, a project name, project owner and a due date. It is to be understood that project table 210 is exemplary and that user interface 200 may additionally or alternatively display any other information useful to provide an overview of the projects to the user, such as the names of project participants or number of project files associated with each project. An order of the projects in the list may be based at least in part on the due date associated with each project. The order of the projects in the list may be further based on insights generated for each project as discussed in more detail below.

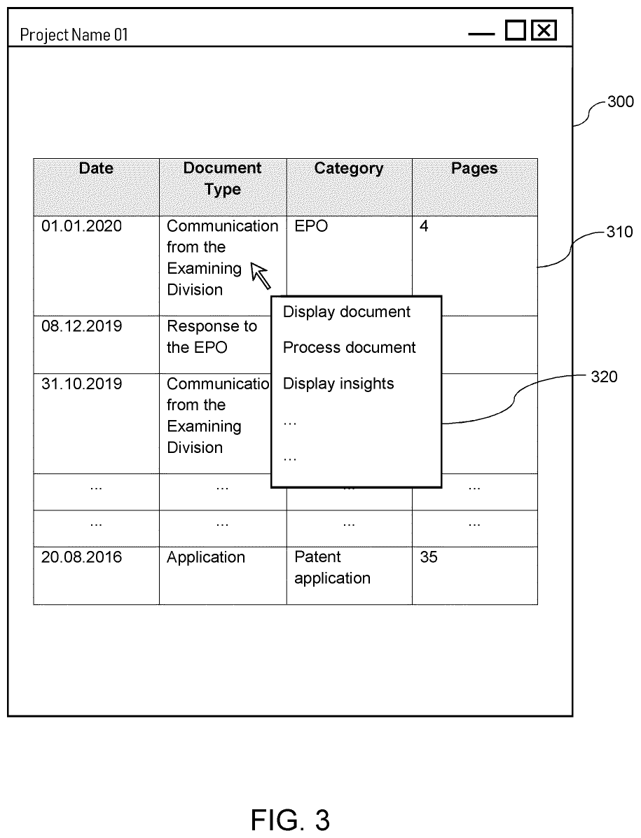

The user may select one of the projects in the list in order to view the electronic project files comprised in the selected project. In response to receiving the user input, the display module 140 is configured to modify the displayed user interface to display the multiple project files included in the selected project to the user. FIG. 3 illustrates an example of such a user interface 300, generated in response to the user selecting Project Name 01.

User interface 300 displays a project document table 310 comprising a list of electronic project files associated with the selected electronic project. Each entry in the list comprises information that provides an overview of the respective electronic project file to the user. The user may select an entry in the list in order to view the respective file, generate further information such as performance metrics and insights and/or view performance metrics and insights associated with the file or project participants associated with the file. For example, as illustrated in FIG. 3, selecting or hovering a cursor over one of the entries in table 310 may cause the display module 140 to display a menu comprising selectable options. The options may include displaying the content of the electronic project file, processing the electronic project file, displaying aggregated information (e.g. performance metrics, insights, statistical information and/or other documents) associated with the electronic project file and so on.

Turning back to FIG. 1, the project workflow module 130 comprises at least one project state unit 135 that periodically accesses the data sources 160 to retrieve new data and to update existing data as stored in the data sources 160. The project state unit 135 checks the status of the project files periodically, such as daily, weekly, monthly or the like, and if a project state difference is identified, activates the project file retrieval to ensure the project is always up to date for the project owner. Additionally or alternatively, the data sources 160 may be configured to notify the project workflow module 130 whenever a new electronic project file is received by the data sources 160. In response to receiving the notification, the project workflow module 130 may retrieve the respective electronic project file for processing by the data insights module 120.

The project state unit 135 comprises known means to automatically retrieve the electronic project files of the project from the one or more data sources 160 based on a unique identifier previously defined by a user, such as an EP application and/or an internal reference number and/or agent and/or applicant name or any other suitable identifier. The project state unit 135 can automatically retrieve the relevant project files from public web-based resources and/or internal resources and connect them to the project, since usually all project files are connected by said at least one unique project identifier, such as the European patent application number. The project state unit 135 stores the project files to the one or more data sources 160 for later retrieval by a user and for further processing by the electronic project assistance system 110.

The data insights module 120 is configured to process at least one electronic project file. As described above with respect to FIG. 3, the data insights module 160 may be configured to process the at least one electronic project file in response to a user input selecting the at least one electronic file. Additionally or alternatively, the data insights module 120 may automatically process the at least one electronic project file whenever a new electronic project file is received by the electronic project assistance system 110.

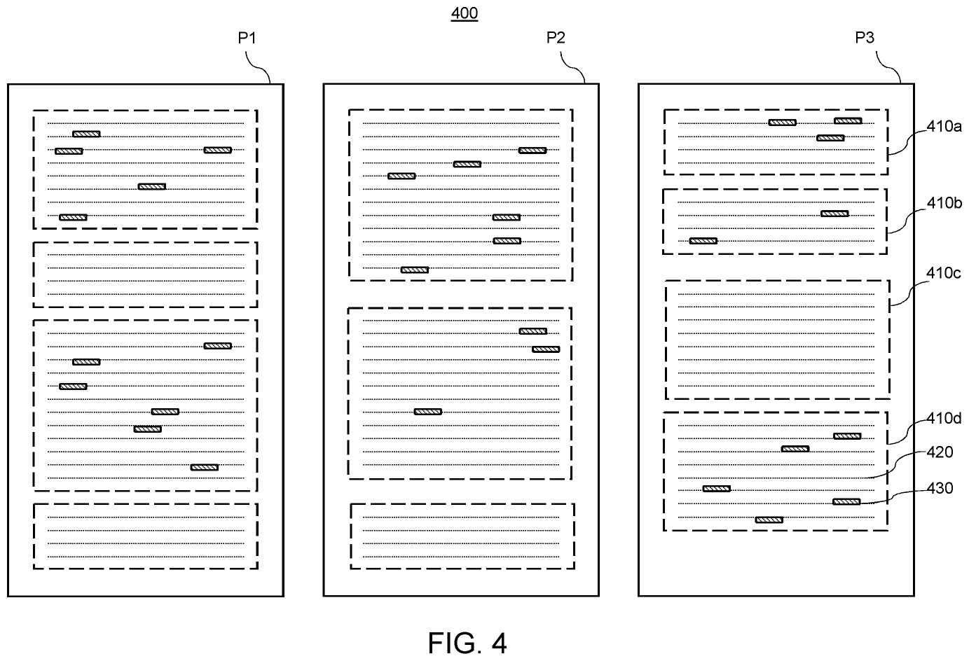

FIG. 4 shows one example of an electronic project file, specifically an electronic project document 400 with multiple pages P1, P2 and P3. It is to be understood, however, that an electronic project document may have any number of one or more pages, or be a long document without distinct pages as explained above.

When a user inputs a selection to view an electronic project document, the electronic project document may be displayed to a user in any suitable manner. The display module 140 may send an instruction to the project workflow module 130 to retrieve the electronic project document from the one or more data sources 160. The project workflow module 130 then provides the electronic project document to the display module 140 and the display module 140 generates a user interface to display the document.

Each page comprises one or more content segments 410 illustrated by the boxes having dashed lines. For example, electronic project document 400 is illustrated as having four content segments on page P1, three content segments on page P2 and four content segments 410a, 410b, 410c and 410d on page P3.

A content segment 410 can be an original text paragraph of the document 400 or a text segment formed during processing of the document 400 by the data insights module 120. As illustrated in FIG. 4, each content segment has one or more lines of text 420 illustrated by the dotted lines within the text segment boxes. Each line of text 420 might include one or more entities of interest 430, illustrated as shaded boxes. For example, text segment 410a on page P3 shows four lines of text of which the first line of text has two entities of interest 430. In a similar fashion, text segments 410b and 41 Od on page P3 comprise two entities of interest 430 and five entities of interest 430, respectively. Text segment 410c on page P3 comprises no entities of interest 430. Pages P1 and P2 also show text segments with entities of interest 430 in some of them, whereas each of pages P1 and P2 additionally have a text segment with no entities of interest 430.

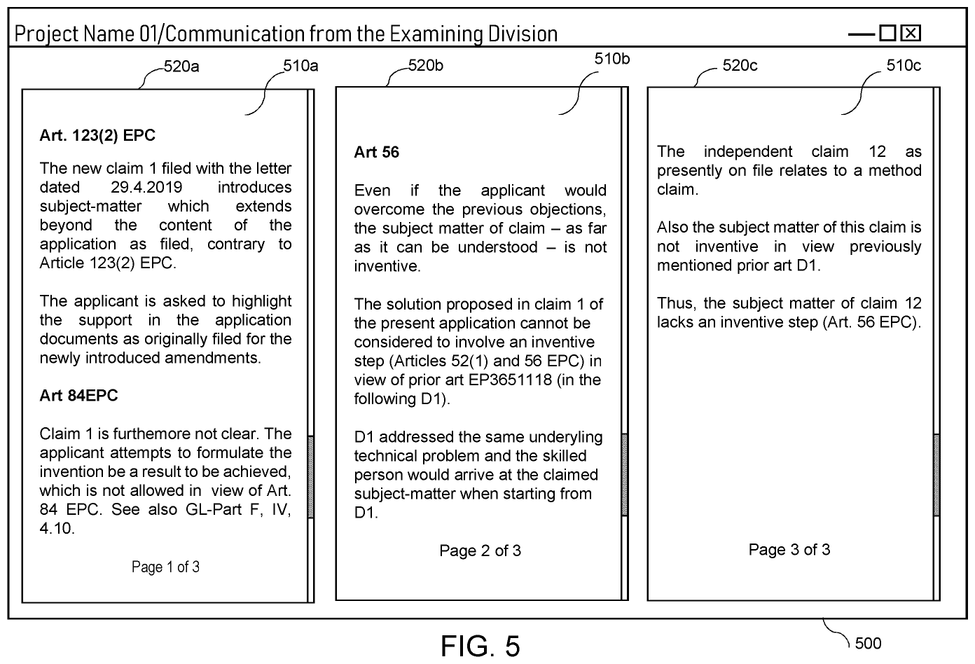

For example, FIG. 5 shows an example of a user interface 500 generated by the display module 140 for displaying an electronic project document 510. In this example, electronic project document 510 is an official communication issued by a competent patent office and visualized in a browser window. Thus, one document source of the electronic project document 510 is the competent patent office. Further, the exemplary official communication is drafted by an Examiner who is therefore a further document source of the electronic project document 510. In some jurisdictions, Examiners may work as part of a team, such as the Examining Division at the EPO. In such a case, a further document source is the Examining Division. The recipient of the electronic project document 510 may be a patent attorney or agent working at a law firm or within a company. Thus, the patent attorney/patent agent and law firm/company may be further document sources.

This exemplary official communication has in total three pages 510a, 510b, 510c. In the example, three panels 520a, 520b, 520c are displayed. Each panel displays at least a portion of a page of the document, the user being able to scroll down (indicated by the scroll bars to the right of the panels) to see the remaining portions of each page. As shown in FIG. 5, each page of the document comprises multiple content segments, which are the original paragraphs of the document. For example, as illustrated in the figure, entities of interest include several objections and references to legal articles of the EPC, reference to legal concepts and a reference to a legal text, reference to prior art.

Turning back to FIG. 1, processing the received at least one electronic project file by the data insights module 120 comprises analyzing the one or more content segments to identify one or more entities of interest, if any. The data insights module 160 may be configured to analyze the at least one electronic project file in response to a user input selecting the at least one electronic file. Additionally or alternatively, the data insights module 120 may automatically process the at least one electronic project file whenever a new electronic project file is received by the electronic project assistance system 110. Additionally or alternatively, the data insights module 120 may be configured to analyze each of the one or more content segments automatically in response to receiving the electronic project document at the electronic project assistance system 110. Additionally or alternatively, the data insights module may be configured to analyze each of the content segments in response to receiving a user input selecting a respective content segment.

Although a content segment is illustrated as a text segment, it is to be understood that a content segment may be an image, video or audio embedded in the electronic project document. In addition, the electronic project file may be an image, a video or audio file and a content segment may be a portion of the image, a frame of the video content, or a portion of the audio file.

When the content segment is a text segment, an entity of interest is a predefined word, phrase or expression. For example, an entity of interest may be a name of a project participant, a project, a product, a technical concept and so on. In the example where the electronic project relates to a patent application, an entity of interest may be a reference to a legal article of the EPC, reference to an objection, reference to a case law decision, reference to a legal topic (such as ex post fact analysis, undue burden and so on), reference to a technical concept, reference to an Examiner name, Examining Division, Opposition Division (OD) or OD member name, Board of Appeal (BoA) or BoA member name, Patent applicant, Patent Applicant Agent, Opponent, Opponent Agent and the like. The data insights module 160 parses the one or more content segments to identify entities of interest using any suitable technique known to the skilled person.

When the content segment is a portion of an image, a frame, or a portion of audio content, an entity of interest may be a predetermined face or object appearing in the image or in a video frame, a predetermined spoken word or phrase and so on. The data insights module 160 may analyze the content segment to identify entities of interest using any suitable technique for identifying objects in image data or sounds in audio data known to the skilled person.

The identified entities of interest are stored in the one or more data sources 160. The identified entities of interest may be subject to further data processing by the data insights module 120 to calculate performance metrics, data insights, trend data and other statistical information. The performance metrics and data insights can then also be stored in the one or more data sources 160.

Each entity of interest may belong to one or more categories of entity of interest. Referring back to the example above, a name of a project participant would be classified in the project participant category, a project name would be classified in the project category, a product name would be classified in the product category, and a technical concept would be classified in the technical concept category. In the example where the electronic project relates to a patent application, a reference to a legal article of the EPC would be classified in the legal article category, law category and/or legal topic category, reference to an objection would be classified in the objection category, reference to a case law decision would be classified in the case law category, the law category and/or the legal topic category, reference to a legal topic would be classified in the legal topic category, reference to a technical concept would be classified in the technical concept category, reference to an examiner name would be classified in the examiner and/or project participant category, reference to an Examining Division would be classified in the examining division and/or project participant category, and the like. If the electronic project document 400 was issued by the European Patent Office, the one or more entities of interest are therefore identified as having the category EPO objection. If the objection is identified in an opponent response letter, the objection category is an opponent objection to either the project owner's position and/or to the position of the EPO, i.e. the opponent objection is a disagreement expressed by one party to a statement of another party. However, the objection can also be of the category that the objection is identified in the project owners' previous project files, i.e. own submissions that the project owner made and/or in project files inherited by a current project owner from a previous project owner and then identifies the project owners disagreement to another party.

Further, each category may comprise one or more sub-categories, referred to as types. For example, where the entity of interest belongs to the project participant category, the entity of interest may be of the type applicant, examiner, inventor, patent attorney, project owner etc. Where the entity of interest belongs to the objection category, the entity of interest may be of the type patentability, clarity, extended subject-matter, priority or any other legal provision objection type and/or on a disagreement on a legal topic, such as disagreement on a legal topic such as late filed arguments, burden of proof or other legal topics and/or disagreement on case law, guidelines for examination as is well known to the skilled person. In other words, the entity of interest type is an insight that provides detailed information about the type of the entity of interest.

Accordingly, upon processing of each electronic project document 400, the data insights module 120 determines at least one category and at least one type of each entity of interest 430. For this purpose, the data insights module 120 may comprises at least one entity identification unit 120a that is configured to classify each entity of interest by category and type.

The data insights module 120 may further comprise at least one entity status classification unit 120b that classifies the entities of interest 430 as having at least one status type. The entity status type is another form of insight that enables a user to differentiate between entities of interest of the same category/type. Entity status types may comprise entity status new (for example, when the identified entity of interest has not been previously identified in other electronic project files associated with the project) or entity status maintained (for example, when the identified entity of interest has been previously identified in other electronic project files associated with the project).

Continuing the example of an electronic project relating to a patent application, if an entity of interest is of the objection category, the entity status classification unit 120b may classify the entity of interest into at least one of the following four objection status types: (i) entity status new, (ii) entity status maintained, (iii) entity status overcome, and (iv) entity status other. Here status type “new” refers to an objection that is newly introduced by for example the Examining Division, Opponent, Opposition Division and/or Board of Appeal. Status type “maintained” refers to an objection that has previously been introduced and is maintained in a subsequent exchange. Status type “overcome” refers to an objection status type that indicates that a previously raised objection was resolved, in other words overcome. Status type “other” refers to potential future objections or a mere disclaimer statement or no objection at all. It is quite frequent that judicial bodies, such as the EPO or any other patent and trademark office will add references to legal provisions and/or case law outlining potential future objections, if certain criteria are violated. EPO Examiners usually add such objection types under a “Miscellaneous” chapter and depending on the topic will define “When filing amendments, Art. 123(2) EPC should be considered” or similar statements depending on the referenced legal provision and/legal topic. Such objections are classified as objection status “other”.

The data insights module 120 may further comprise at least one entity intensity score unit 120c that determines at least one intensity score for each identified entity of interest 430. The intensity score is associated with a perceived difficulty of successfully completing the project associated with the electronic project document. The entity intensity score unit 120c therefore enables further differentiation of identified entities of interest of the same category/type and provides an insight into the likelihood of success of the project. The at least one intensity score may be determined based on one or more of a category of the entity of interest, a type of the entity of interest, a status of the entity of interest, and a document source associated with the electronic project document comprising the entity of interest.

For example, if the project relates to a patent application and an identified entity of interest is of the objection category, the entity intensity score is referred to as an objection intensity score. An objection that is very negative and deemed to be very difficult to be overcome would, for example, have a high objection intensity score, while an objection referring to only a formal objection would, for example, have a low objection intensity score. Further, text segments with the category “other” could even have the score zero, if the other category is that no objection was identified.

The entity identification unit 120a, the entity status classification unit 120b and the entity intensity score unit 120c are illustrated as components of the data insights module 120. However, this is exemplary and the entity identification unit 120a, the entity status classification unit 120b and the entity intensity score unit 120c may be one or more standalone units configured to communicate with the data insights module 120. Additionally, there might be one or more of each of the entity identification unit 120a, the entity status classification unit 120b and the entity intensity score unit 120c.

The data insight module 120 may be further configured to determine further insights based on the insights generated by the entity identification unit 120a, the entity status classification unit 120b, the entity intensity score unit 120c and any metadata associated with the project and/or the electronic project document. The metadata may include any additional information about an electronic project file that is received with or extracted from the electronic project file, such as a unique reference number for the file, date of creation, date of receipt, document source, project participants etc. For example, the data insight module 120 may determine a project complexity score for the project and/or the project document based on one or more of a type of the entities of interest, a status of the entities of interest, the document source and any other retrieved aggregated information. The project complexity score provides an indication to the user of the complexity of the project, thereby providing an indication of how long a project (or a step of the project) will take to complete.

The insights generated by the data insight module 120 (e.g. entity type, entity category, entity intensity score, entity status, project complexity score etc.) may be stored in data source 160 to update and expand the data source 160 with new insights. The project workflow module 130 may be configured to update said data. The project workflow module may update the stored entities of interest and data insights determined by the data insight module periodically or whenever a new electronic project document 200 is processed.

As described above, the one or more data sources 160 store the electronic project files, identified entities of interest and aggregated information including the determined performance metrics and data insights such as entity category, entity type, entity intensity score, entity status and so on. The one or more data sources 160 additionally store the metadata associated with the electronic project files.

The one or more data sources 160 may additionally store documents and other information associated with the project. For example, patent applications and their corresponding dockets, such as the European patent application as published and its corresponding register dockets. The one or more data sources 160 may store other electronic project files comprising documents associated with but not part of the project. For example, such other electronic files may comprise legal documents relating to legal provisions and the case law, such as the Board of Appeal of the European Patent Office (EPO) or any other judicial body. Such other electronic files may comprise publications material relating to examining patent applications by the staff of the EPO, such as the Guidelines for Examination, the European patent convention and the case law book of the EPO Boards of Appeal, the PCT treaty and other similar publications.

The at least one project state unit 135 may periodically access a set of external systems and external data sources to obtain such documents. For example, the at least one project state unit 135 may access the EPO Open Patent Services, the EPO's master documentation database (DOCDB), EPO legal status data and the like, to retrieve new data and to update existing data as stored in the data source 160.

The one or more data sources 160 may be servers that store the data in any suitable manner that allows the electronic project assistance system 110 to efficiently access and store data as described above. Each of the one or more data sources 160 may store different types of data. For example, data source 160a may store electronic project files and their associated metadata, such as data relating to document sources and project participants. Data source 160b may store processed or partly-processed electronic project files including identified entities of interest. Data source 160c may store performance metrics and data insights.

In addition, the data sources 160 can also include one or more databases comprising calculated performance metrics and data insights associated with document sources and/or project participants. This data may have been generated by the data insights module 120 as described above. For example, the data sources 160 may comprise performance metrics and data insights associated with EPO Examining Divisions, Patent Examiners, Opposition Divisions, Opposition Division members, legal topics and/or other functions of the EPO. Example of metrics are general grant rates, Oral proceedings metrics, citation frequency of certain decisions and other similar metrics.

One or more of the data sources 160 may store data insights for a specific type entity of interest. For example, where the entity of interest is an objection, data source 160d may be a global objection insights data source which stores information as provided by the data insights module regarding objection insights. One example of such global objection insights data source 160d relates to a collection of objections identified within project documents submitted to EPO and/or sent by the EPO. Such a collection across more just one project, in this example more than just one EP patent applications, can comprise collection of objections from any procedural stage before the EPO, i.e. examination, opposition or appeal stage. The global objection insights data source 160d provides the actual text of identified objections from any of the Examiner, Examining division, Opponent, Opposition Division, Appeal Board, Appeal Board member, Opponent (Opponent Agent), Patent applicant (Patent Agent) and also stores metrics and other data associated with the global objection insights and as processed by the data insights module, such as for example number of objections, type of objections, source of objection, intensity of objection, status of objection and/or combinations thereof and other aggregations or metrics.

The electronic project assistance system enables the user to access and view aggregated information associated with each project, project participant, project file by dynamically generating user interfaces in response to user input. The project workflow module 130 and the display module 140 are configured to communicate for generating user interfaces. Specifically, the display module 140 generates user interfaces based on user input and/or instructions received from the project workflow module 130. Specifically, in response to a user input, the data insights module 120 is further configured to retrieve aggregated information stored in the at least one document source 160 and provide the aggregated information to the display module 140 for displaying to the user. The display module 140 then modifies the displayed user interface to display the aggregated information.

As a first example, a user may select a project to view insights relating to that project. For example, referring back to the user interface 200 of FIG. 2, a user may select one of the projects in the table 210 to view aggregated information associated with the selected project. In response to receiving the selection of the project via user interface 200, the display module sends instructions to the project workflow module 130 to retrieve aggregated information associated with the selected project. The project workflow module 130 then sends the aggregated information to the display module 130 for generating the modified user interface.

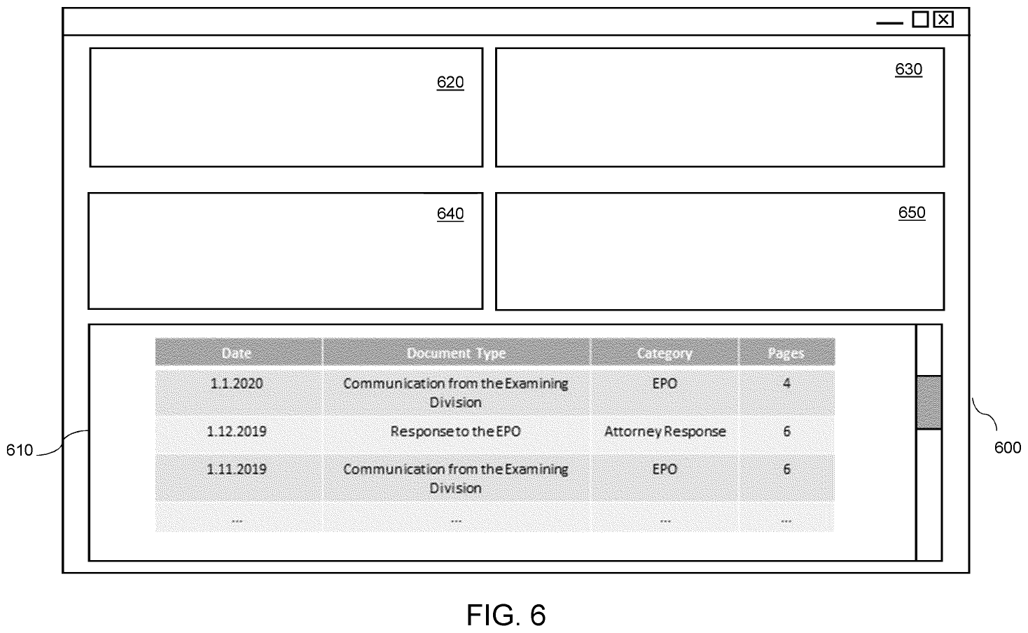

FIG. 6 illustrates an example of such a user interface 600 in the form of a project main page generated by the display module. The project main page 600 comprises multiple panels 610 through 650 that each display different information relating to the selected project. For example, the multiple panels may display project owner name, project information, project access, project data insights, project statistics, metrics and the like.

In particular, panel 610 shows a project document table comprising a list of multiple project files associated with the project. Each entry in the list comprises, for example, the project name, project owner and/or project participants, a due date and any other information useful to provide an overview of the selected project to the user.

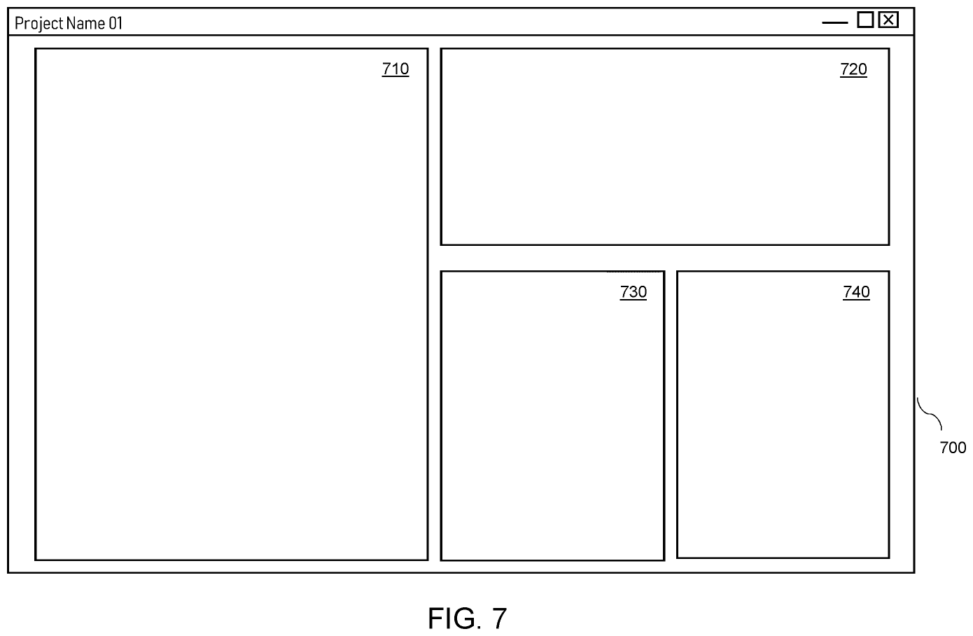

Selection of a project displayed within panel 610 may cause the display module 140 to modify user interface 600 to display a project sub-page corresponding to the selected project. FIG. 7 shows an example user interface 700 displaying the aggregated information within a project subpage. The project sub-page has at least one sub-page panel. For example, the project sub-page illustrated in FIG. 7 has four sub-page panels 710, 720, 730, 740.

As a second example, a user may select to view insights relating to projects associated with the user or with another user. The user and/or another user may be project participant, project owners or any other user authorized to access the project in the electronic project assistance system 110. In response to receiving the selection of the user, the display module sends instructions to the project workflow module 130 to retrieve aggregated information associated with the selected user. The project workflow module 130 then sends the aggregated information to the display module 130 for generating the modified user interface.

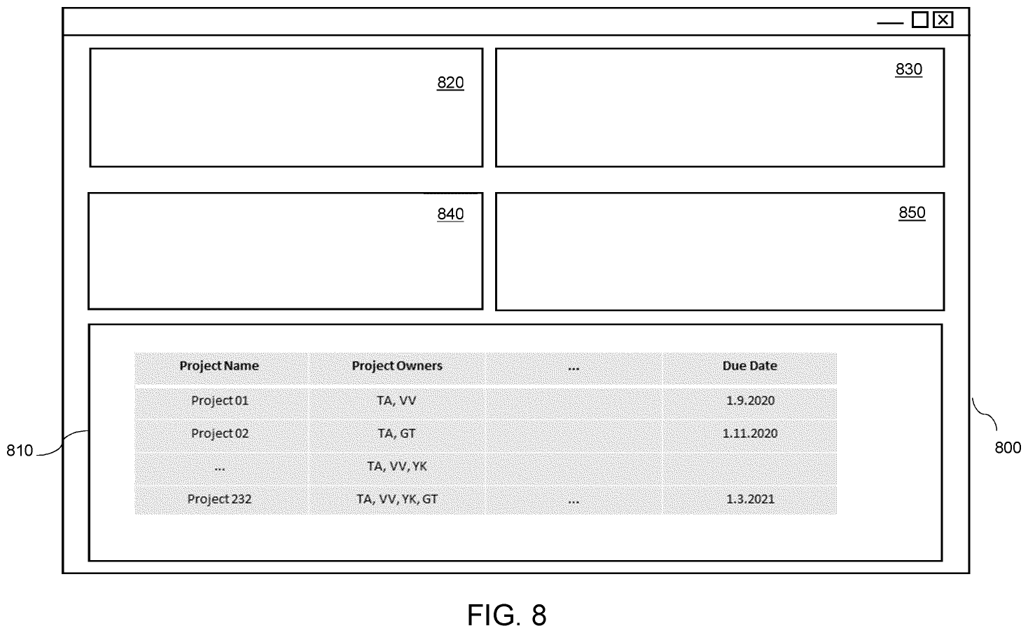

FIG. 8 shows an example of such a user interface 800. User interface 800 comprises a project table panel 810 that displays a list of projects associated with the selected user. The project table panel 810 shows a project table with one project listed per row in this example. Each project in the table is associated with additional information, such as open action items, time to due date of an open item, response to an Official Communication, one or more project tags, and the like. The project table 810 includes a plurality of columns, of which only three are illustrated in FIG. 8. The column “Due Date” provides a rank of the projects by an official due date, such as responding to an Official Communication from the EPO. However, in response to a user input, the ranking of the projects may be updated and the display modified based on insights determined by the data insights module 120 in order to provide the user with a visual indication of the status and priority of the projects.

The user interface 800 can provide further information via additional panels, such as panels 820 through 850, displaying charts and/or metrics relating to the underlying projects listed in the table 810. The user can select to only include one or more of the projects to be included in the chart visualization. The user can open the desired project, such as Project 01 and will have it rendered in a project main page, such as the project main page 700 described in relation to FIG. 6. Each project shown in the project table can be opened in its own project main page if desired by the user.

As a third example, a user may select at least a portion of an electronic project file to view insights associated with that portion of the electronic project file. For example, the user may select one or more content segments to view insights relating to entities of interest identified within the selected one or more content segments. For example, referring back to the user interface illustrated in FIG. 5, a user may select a first content segment of the plurality of content segments in order to view insights associated with the content of the content segment.

Specifically, in response to the user selection, the project workflow module 130 may retrieve from the one or more data sources 160 aggregated information associated with the one or more entities of interest identified within the selected first content segment. The aggregated information may be further associated with the at least one document source associated with the electronic project document. The aggregated information may comprise at least one of statistical data, performance metrics, trend data, multiple documents and any other insights stored in the one or more data sources 160 as described above.

The aggregated information may be displayed within one or more panels within the user interface. For example, in response to the user input selecting the first content segment, the display device 140 may modify the display to display in a first panel the first content segment and to concurrently display in a second panel retrieved aggregated information associated with a first entity of interest corresponding to the first selected content segment and associated with the same at least one document source. A third panel may concurrently display at least a portion of at least one electronic project document associated with an entity of interest of the same type as the first entity of interest and associated with the same at least one document source. A fourth panel may display an indication of a current state of the project associated with the at least one electronic project document with respect to the first entity of interest and indication of a predicted future state of the project associated with the first entity of interest.

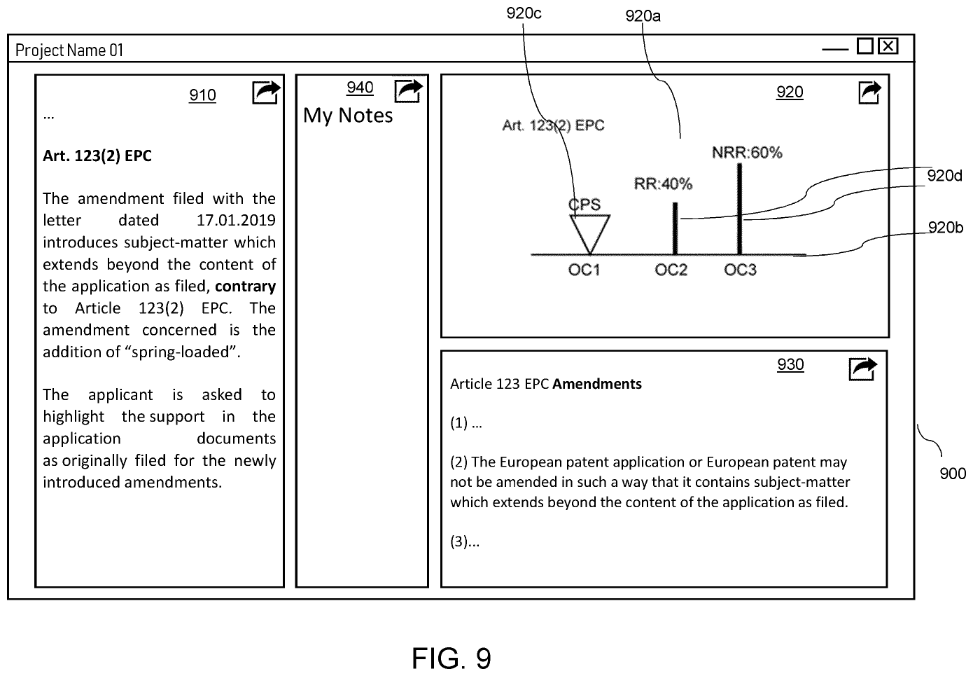

For example, FIG. 9 illustrates a user interface 900 generated by the display module 140 in response to a user selecting a first set of content segments. A first panel 910 displays several content segments comprising a first entity of interest. The example of FIG. 9 illustrates the entity of interest as an objection of an underlying electronic project document, here an Official Communication from the EPO. Panels 920 and 930 display retrieved aggregated information associated with the entity of interest. Panel 920 displays statistics associated with the entity of interest and the same at least one document source as the entity of interest. Specifically, panel 920 displays a timeline user interface element 920b. The timeline user interface element 920b is a timeline that displays events associated with the project (i.e. stages of the project) in a chronological order. The timeline user interface element further includes, for each stage of the project, aggregated information such as statistics associated with the entity of interest and/or the document source. Panel 930 displays a portion of another electronic document associated with the entity of interest, illustrated in the example as a portion of legal text relating to the objection. A fourth panel 940 may be used by the user to input user notes.

The statistics illustrated in panel 920 comprise an objection risk graphic 920a that highlights information associated with the current project state (CPS) and how it relates to the overall activity of the at least one document source of the Art 123(2) EPC objection, in this example the examiner that issued the official communication. The panel 920 provides data insights for Art 123(2) EPC in the form of a timeline user interface element 920b. The timeline user interface element 920b is labeled with stages of the project. For example, OC1 stands for official communication 1, OC2 stands for official communication 2 and OC3 stands for official communication 3. A marker 920c indicates the current stage of the project (CPS). Thus, the panel 920 visualizes to the user that the current project under review has a current project state (CPS) OC1, i.e. the current project is at a stage in which a first communication was received from the counterparty. In this example, the counterparty is the EPO Examiner.

The panel 920 furthermore indicates predicted future states of the project with respect to the objection using markers 910d. A predicted future state may be associated with the likelihood of obtaining a patent, such as a project rejection score. In the example, markers 920d show that other applications previously reviewed by the author (the examiner) that also had at least an Art 123(2) EPC objection at stage OC1 had 40% of those previous objections got resolved (a resolved rate (RR) of 40%) at stage OC2, and 60% did not get resolved (NRR=none-resolved rate) even at the time of stage OC3, where those previous cases also finally ended. Meaning, 40% of the previous cases including such an objection did succeed to overcome at least the Art 123(2) EPC objection within one (1) Official Communication (OC) from the current project state (CPS). Through the interaction with the first and second panel, the user also gets immediate input and feedback that NRR 60% score effectively means that those underlying previous cases did not make it beyond three Official Communications even. In this manner, the objection risk graphic 920a provides time information to the user, since RR marker is located at OC2 and the NRR marker is located at OC3. If the project rejection score or NRR are above a certain threshold value, a graphical risk warning icon may be displayed.

The figure indicates an objection risk graphic 920 with graphical elements, but in another example the information can also be visualized by text only and/or by a combination of text and graphics. Other information may additionally or alternatively be displayed in the graphic, such as the number of cases (instead of only percentage indication) that included at least an Art. 123(2) EPC objection that were finalized and at what stage said cases were finalized, comparative RR and NRR values of the Examining Division of the author (i.e. Examiner) for the entity of interest shown and the like.

As discussed above, each electronic project document may be associated with more than one document source. Thus, the Examiner that issued the official communication is one document source. Further document sources associated with the official communication may include the Examining Division (not shown) to which the document source Examiner is assigned to with regard to the project document and the EPO. As discussed above, in this example the objection risk graphic 920a provides insights associated with the examiner that issued the official communication as the document source. However, it is to be understood that the objection risk graphic may provide insights associated with any one or a combination of the document sources. The display module 140 may provide the user with a means for selecting the document source of interest to the user and the user may be enabled to toggle between different document sources and combinations of document sources.

Accordingly, a user is provided with an insight into the general objection activity of the Examiner, Examining Division, EPO, patent attorney, patent law firm or a combination thereof associated with Art. 123(2) EPC. More broadly, the user is able to generate and view insights into the activity of a project participant associated with a specific type or category of entity of interest.

These insights provide a clear indication and guidance to the user on how to achieve the greatest work product quality. A none-resolved objection is essentially a faulty work product, since the work product—here the argument and/or amendment of the application—did not resolve the objection. Moreover, not being able to resolve objections eventually leads to the entire application being refused, thus a work product that ends up with low quality work. Having these insights, the project owner, in this case a patent attorney, can implement countermeasures in an extremely efficient manner that will contribute to achieving a higher-quality work product.

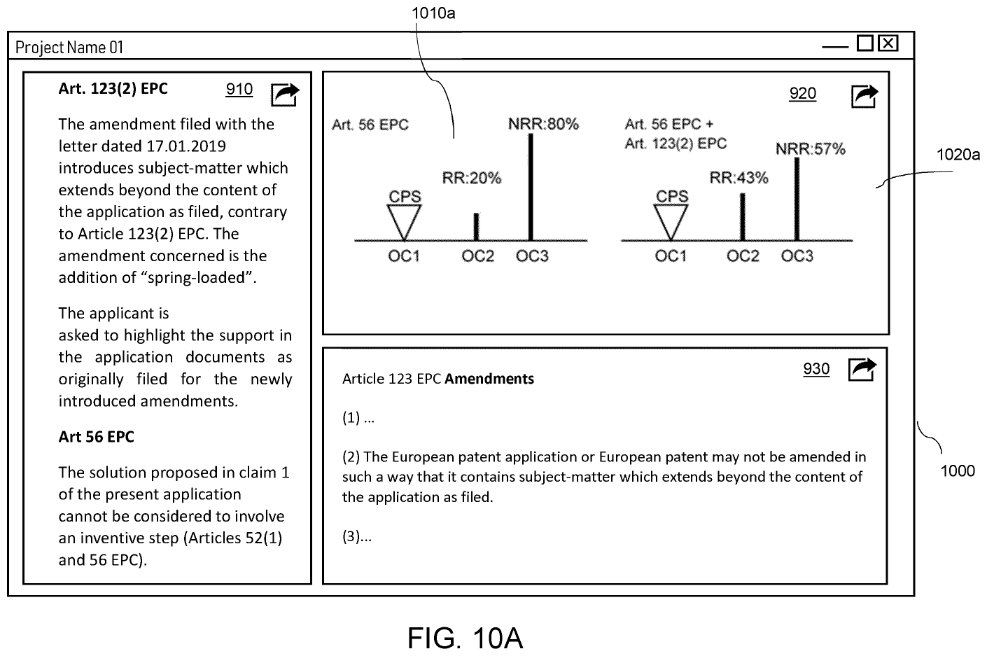

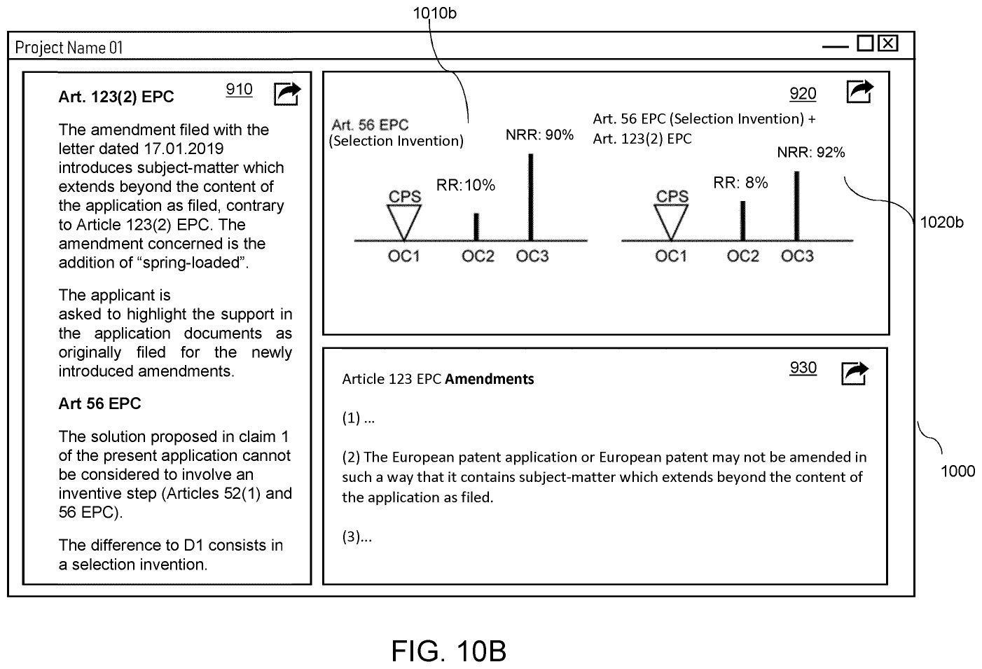

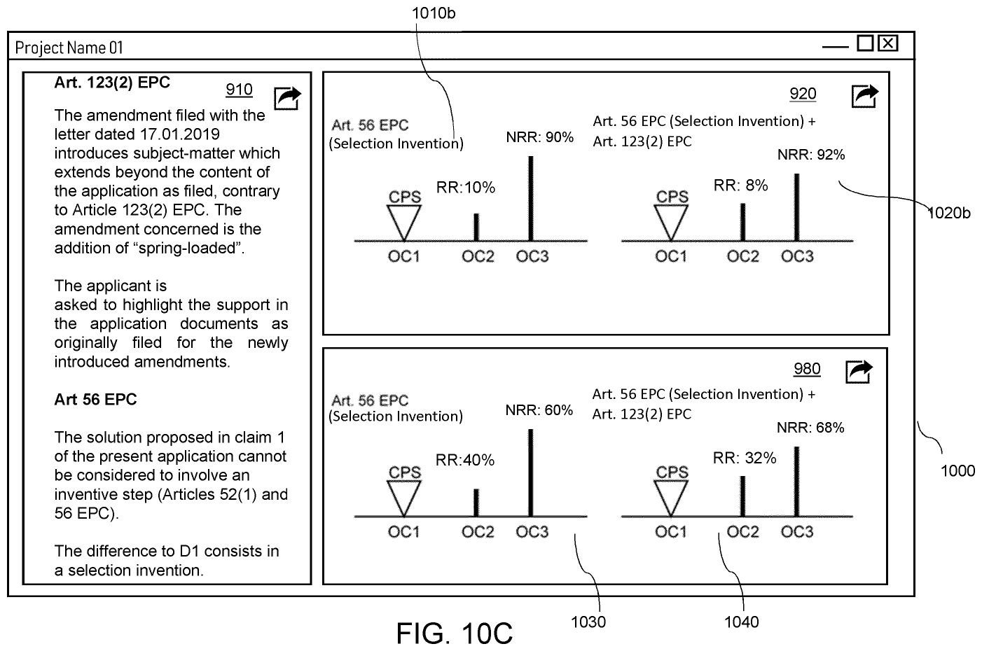

The user interface 1000 illustrated in FIG. 10A continues the example of FIG. 9, except that the user removed the panel 940 and re-sized the panels 920 and 930. FIG. 10A furthermore shows that due to user interaction with panel 910, the first panel 910 has changed. In particular, the user conducted a scrolling operation and can now see further content segments that include a further entity of interest (also illustrated as an objection) in the first panel 910. However, it may be understood that any suitable user input may be used by the user to see further entities of interest, including, but not limited to, resizing panel 910, zooming in or out, selecting by appropriated selection tools specific content segments and/or entities of interest. For example, a user may click on multiple content segments to select the multiple content segments. To select the multiple content segments, the user may directly click on the content segment or the user may click on user interface elements such as check boxes or radio buttons displayed adjacent to each content segment.

Thus, the previous entity of interest (the Art 123(2) EPC objection) and also a further entity of interest (the Art. 56 EPC objection) are displayed concurrently in panel 910. In reaction to the user interaction with the panel 910 (i.e. in response to e.g., the scrolling operation, the resizing operation, the selection operation), the panel 920 is updated automatically to provide statistics now relating to both the Art 123(2) and the Art 56 EPC performance of the author of the document i.e. the Examiner. Thus, the updated panel 920 includes insights that are associated with the entities of interest displayed in panel 910. Specifically, in the example, panel 920 displays an objection risk metric 1010a for the further entity of interest (the Art. 56 EPC objection) and additionally provides a combination risk metric 1020a for the combination of objections Art 56 and Art 123(2) EPC. That is, these insights highlight the pattern of previous cases of the Examiner that included both of these objection types in one and the same communication.

FIG. 10B continues the example of FIG. 10A and shows that due to user interaction with the panel 910, the additional text segment including the legal concept “selection invention” is now shown. “Selection invention” is an established legal concept and as such an entity of interest. Thus, in addition to the two entities of interest (Art 123(2) EPC objection and Art 56 EPC objection), the project document includes a further entity of interest in the shown content segments of panel 910. The aggregated risk metrics comprised in panel 920 are now updated also in view of this identified entity of interest. Panel 920 now displays objection risk metrics 1010b and 1020b for the entity of interest “selection invention” linked to the entity of interest Art 56 EPC objection and thereby visualizing to the user that it was identified in connection to the Art 56 EPC objection. This provides additional immediate insights of value to the user, since an intermediate understanding is provided to the user upon interacting with the panel 910 that the author of the document (i.e. the Examiner) has an even higher risk metric (NRR increased) with regard to this type of entities of interests (Art 56 EPC objection combined with “selection invention”). Immediate feedback to the user is achieved and such insights will empower to user to achieve the right resource allocation to achieve optimal quality outcome for the applicant.

Of course, due to further re-sizing or user selection further objections or other entities of interest might be displayed in the first panel 910 and then the combination of three or more objection types in one and the same combination risk metric can be provided to the user and it associated risk metrics. As an example only, the user could in the previous example re-size such that all pages of the official communication are displayed in the panel 910 and then obtain an overview in panel 920 on the associated risk metrics.

FIG. 10C continues the example of FIG. 10A, except that the user interacted with panel 930 and removed it, but instead inserted panel 980. Panel 980 shows risk graphics 1030 and 1040 based on the same objections and entities of interest as shown in the risk graphics 1010b and 1020b in panel 920 and also based on the content segments shown in panel 910. However, panel 980 calculates the risk graphics 1030 and 1040 for a different document source than risk graphics 1010b and 1020b. For example, panel 920 calculates the risk graphics 1010 and 1020 for the document source Examiner, while panel 980 shows calculates the risk graphics 1030 and 1040 for the document source Examining Division. That is, to provide the user with additional relevant insights, the general risk graphics of the Examining Division associated with the project document shown in 910 is provided in panel 980. This provides an immediate input and feedback to the user, with regard to how the Examiner risk graphics compare to the relevant Examining Division.

While in this example the risk graphics of the Examining Division and the current Examiner are shown in separate panels, the risk graphics can alternatively be combined in and the same panel and the bars of the Examiner risk values and of the Examining Division risk values would be shown side by side along the time line.

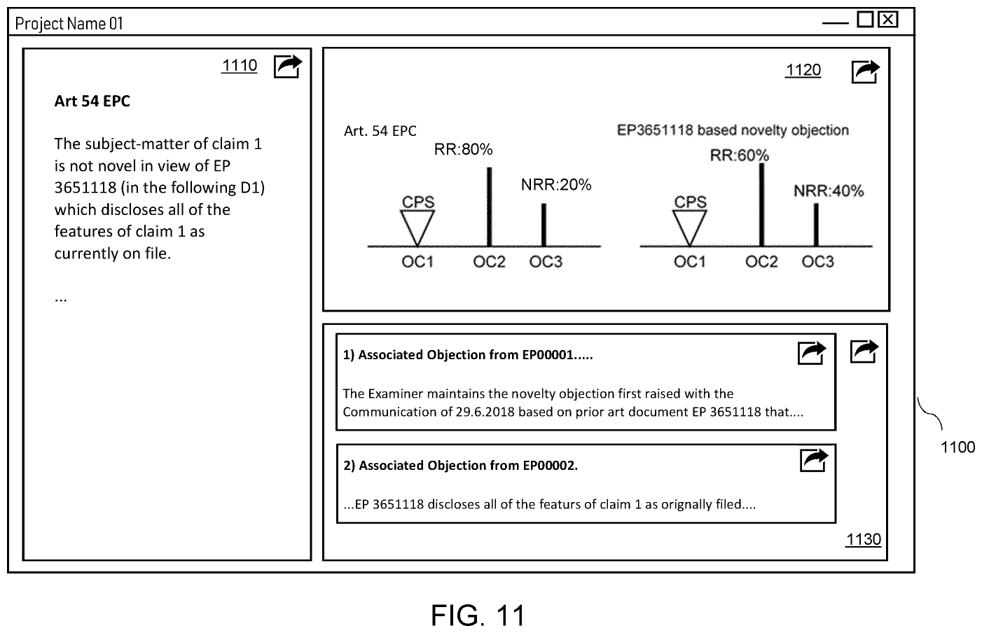

FIG. 11 continues the example of FIG. 9, except the user has now selected a different content segment comprising a further entity of interest. The further entity of interest, an objection, is shown in panel 1110 of user interface 1100. The objection is an Art. 54 EPC (novelty) objection based on another document named EP 3651118. The reference to the prior art document (here EP3651118) is itself an entity of interest. In other words, the novelty objection is associated with an electronic document other than the electronic project document associated with the content segment displayed in panel 1110. Panel 1120 is provided in which an objection risk graphics associated with the novelty objection is shown. The risk graphic based on the Art 54 EPC novelty objection alone from the current Examiner indicates a RR rate of 80%, while in addition a risk graphic based on the novelty objection based on the identified prior art document is also presented. Thus, this insights in itself is of value to the user, who know is presented with the insights that the Examiner has previously relied on the same prior art document and most likely has a very good understanding of its contents. Especially, the risk graphic for the combination of Novelty objection and the prior art document indicates to the user that the RR is lower (60% only, compared with Novelty objection in general of 80%) when the Examiner relied on this prior art document.

Thus, panel 1120 has been modified from panel 920 by the display module 120 to display a risk graphic associated with the entities of interest shown in panel 1110 instead of the entities of interest according to FIG. 10. Panel 1130 displays at least a portion of other documents associated with the entity of interest shown in panel 1110 and having the same document source as the entity of interest. In this example, panel 1130 shows other objections raised by the same underlying EPO counterparty (document source), here the Examiner, in which the Examiner cited the same prior art document EP3651118 for a novelty objection. Panel 1130 shows the first two associated objections, while the user can interact by simple scrolling operation with the panel 1130 to identify further objections obtained from the global objection insights data source 160d.

At least a portion of the user interfaces described above may be shared with one or more users. Specifically, turning back to FIG. 1, the project sharing module 150 is configured to enable selective sharing of project documents, performance metrics and insights. For example, the project sharing module 150 can be configured to share an entire user interface, and/or only a partial user interface by sharing only one or more project panels of said user interface.

A user may select one or more panels by selecting a panel sharing icon displayed in each panel or in any other suitable manner. In response to receiving a selection of one or more panels, the project sharing module 150 generates a collaboration project space comprising the selected one or more panels. The project sharing module 150 then identifies at least one other user as a collaborator to receive access to the collaboration project space. The at least one collaborator may be selected from among the project participants or may be a user who, prior to the selection, is not a project participant. If the collaboration project space comprises two or more panels, the project sharing module 150 can additionally or alternatively be configured to share a first of the selected two or more panels with at least a first collaborator as a first collaboration space and at least a second sub-page panel with at least a second collaborator as a further collaboration space. Thus, the user interface panels are configured such that each panel can be shared individually or in combination with one or more recipients. The recipient will receive a copy of the shared content only of the selected panel. That is, the user is in control which panels a recipient will get access to.

The project sharing module 150 is configured to determine the at least one collaborator based on the retrieved aggregated information. The system will automatically prompt the user with one or more relevant collaborators based on the retrieved aggregated information. Said collaborators may not have previously been associated with the current project by the project owner.

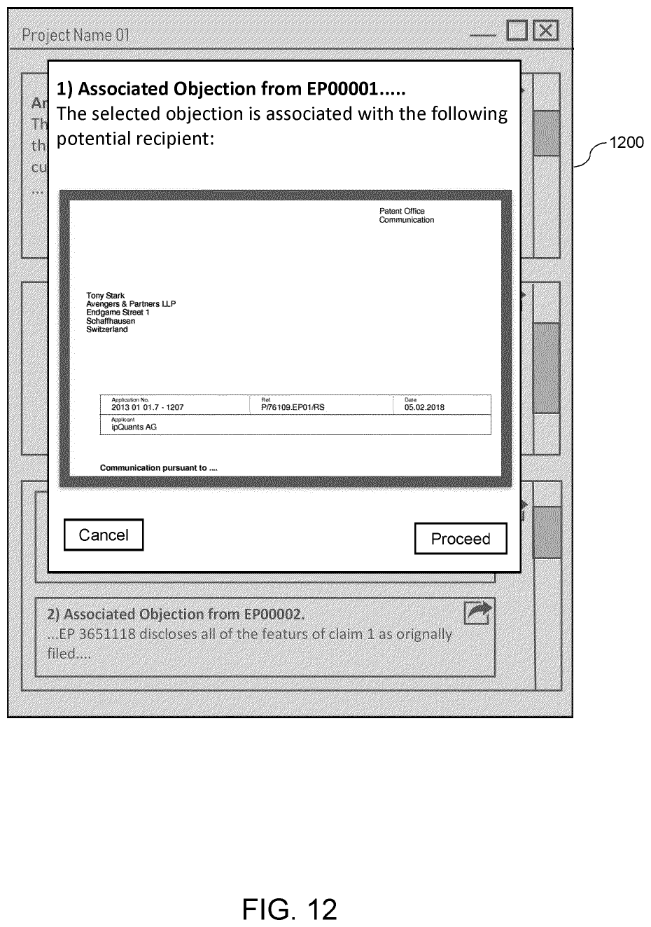

FIG. 12. shows a user interface 1200 generated by the display module 140 in response to instructions received from the project sharing module 150. If the project user decides to proceed with sharing a panel, the system will automatically present a potential recipient (collaborator) by presenting potential recipient information from a potential recipient project. The potential recipient information is for example at least one recipient project document that includes recipient name and address and the recipient's internal reference sign. This significantly increases the efficiency of the user, since identifying a previously unknown collaboration partner is automated, while having higher quality outcome due to the relevance to the project owner's current objection. This eventually increases the quality of the work product produced by the project owner, because the project owner receives valuable timely input to prepare counter-arguments.

In addition to providing insights, the project workflow module 130 may be configured to assist a user in prioritizing workflows. The project workflow module 130 is configured to automatically access the data sources and retrieve the stored information associated with project for which the project user needs to respect an upcoming due date. The upcoming due date corresponds to the date by which an action must be completed by the user on a project. In the context of a patent application, this may be the date by which a submission must be filed with the patent office or a report must be provided to the client.

Project workflow module 130 is configured to retrieve aggregated information associated with the project, such as the metadata associated with the project (e.g. project participants, document source etc.), electronic project files associated with the project, and insights determined by the data insights module 120 (e.g., entity categories, entity types, entity status type, entity intensity score, project complexity score, project rejection score etc.). The project workflow module may retrieve said aggregated information from the one or more data sources 160. Additionally or alternatively, at least a portion of said aggregated information may be retrieved from the data insights module 120.

Based on the retrieved information, if the project workflow module 130 may determine that the next project to be completed based on the due date as specified indeed has a higher response complexity and/or comprises entities with higher entity intensity scores than the other projects of the project owner, the project workflow module 130 is configured to instruct the display module 140 to display within the user interface a graphical indication. If any of the other projects is assessed to have a higher response complexity, the project workflow module will at least instruct the display module to render a graphical warning to the project user.

For example, if the project workflow module 130 determines that an entity intensity score and/or a project complexity score associated with an electronic file of the project is above a predetermined threshold value, the project workflow module 130 may instruct the display module to display a graphical warning to the user. The graphical warning icon may be in the form of a pop-up user interface element that is displayed in any of the user interfaces associated with that project. The graphical warning icon may comprise highlighting the project within a list of projects such as the project table 210 shown in user interface 200. The graphical warning icon may comprise highlighting the respective project file within the list of project files such as the project file table 310 shown in user interface 300.

Referring back to FIG. 2, showing projects listed in the project table 210 along with their respective due dates, said projects may initially be listed in order of due date. However, in response to receiving the aggregated information, the project workflow module 130 may instruct the display module 140 to modify the user interface 210 such that the order of the projects in the list is based at least in part on the upcoming due date and at least one of the project complexity score and the objection intensity score associated with each of the projects. The user is therefore automatically prompted by the system to review a project that is of greater complexity, therefore requiring more time to complete, than a project with of lower complexity.

With regard to all user interfaces described herein, the user may input a selection or command in order to select which aggregated information, such as particular insights, trends, statistical data and project states is shown. Thus, the display module 140 provides a user with means for making selections and submitting commands that allow the user to directly set processing conditions for the stored information relating to each identified entity of interest without knowledge of programing or the data structure of the data stored in the one or more data sources 160. Further, since the user interface is modified in response to a user selection (for example, the information displayed in the panels is modified in response to selection of a further entity of interest), the user is provided with a continued and guided human-machine interaction that enables the user to analyze and have an overview of large amounts of data efficiently. Furthermore, the panels and information therein may be concurrently displayed within the user interface, meaning that the panels and information therein are displayed at the same time to the user. This significantly increases the efficiency of the project user, who now has all the relevant information on one display interface. The concentration level of the user is also improved, and thereby the quality of the work product, since the first project view displays the project objection by taking into account the location of its position within the project document. Thus, the user is not distracted by the other pages of the project document and can focus more easily.

Furthermore, the panels may be arranged such that at least one panel displaying performance metrics, insights, trend data and other statistical data is displayed is arranged in close proximity to the electronic project document in order to assist the user in focusing on said data. This allows displaying the relevant metrics, insights, trend data and other statistical data where and when the user would need such data the most, i.e. when the user reviews the electronic project document. Similarly, graphical warning icons may be displayed near the user's current focus of visual attention such that the risk warning is more or less guaranteed to be seen immediately. Thus, the graphical warning icons may be displayed near the center of the display. Alternatively, the display module 140 may determine the area of the display on which the user's attention is focused, for example by determining the area of the display in which the user has most recently provided an input or where the cursor is currently hovering, or with readily available eye-tracking solutions of a computer system determining the gaze of the user and thereby deriving where the user's attention is focused.

Furthermore, each panel is re-sizable and re-arrangeable as desired by the user. In other words, a user can resize and move panels displayed within the user interface. The user can interact with the scroll bar of each panel to view and interact with the content of each panel. The user may interact with other icons displayed in each panel in order to perform actions such as providing user input. Panels can be added and/or removed at any time to create different panel arrangements. It is also to be understood that while the user interfaces herein have been described in terms of “panels”, the term “panel” refers to a portion of a user device screen, but may be additionally understood to refer to a pop-up window and/or separate browser windows. In this respect, a side-by-side layout of the panels (i.e. where the panels are arranged in a plurality of columns) as shown in the figures is advantageous to optimize the available display size. For example, such a layout makes it easier for the user to show more of the electronic project file in a panel by re-sizing that panel, while keeping other displayed panels relatively small.

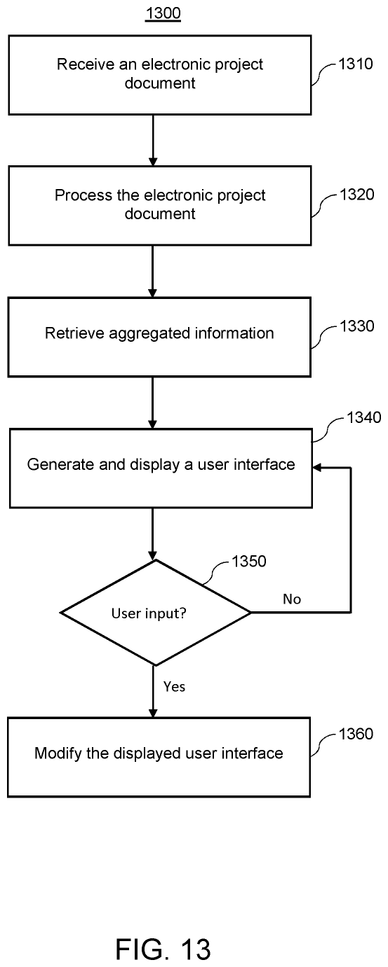

FIG. 13 shows a flow diagram of an illustrative example of a method 1300 of facilitating the processing of project data using the electronic project assistance system 110.

At step 1310 an electronic project file associated with at least one data source is received. The electronic project file comprises one or more content segments. Receiving the electronic project file may comprise retrieving the project file from the one or more data sources as described above with respect to FIG. 1.

The received electronic project file is then subjected to processing steps to extract data insights by the data insights module 120. Specifically, at step 1320, the received electronic project file is processed to identify one or more content segments. The processing further comprises analyzing the one or more content segments as described above with respect to FIG. 1 to identify entities of interest within each of the content segments, if any. The processing may further comprise computing data insights and performance metrics based on the analyzing. For example, the processing may further include classifying the identified entities of interest according to entity categories, entity types, entity status type, entity intensity score, project complexity score, project rejection score etc. The aggregated information obtained from the processing is then stored in the one or more data sources 160.

Based on the determined performance metrics and objection insights, as well as metadata associated with the electronic project file such as the document source, aggregated information associated with the at least one or more entities of interest is retrieved from the one or more data source 160 (step 1330).

At step 1340 a user interface is generated and displayed to the user. As discussed above, the display module 140 is configured to generate user interfaces for enabling the user to view information about the projects managed by the electronic project assistance system 110.

At step 1350, the system waits to determine if user input is received. The user input comprises selection of a graphical element on the user interface, such as selection of an entry in a display table, selection of a content segment, selection of a panel, selection of a graphical icon, scrolling operation etc. If user input is received at step 1350, the method continues to step 1360. If user input is not received the user interface displayed at step 1340 continues to be displayed.

At step 1360 the user interface is modified in response to receiving the user input. Modifying the user interface may comprise modifying the content displayed to the user within at least one panel displayed within the user interface, changing the number of panels displayed, resizing the panels etc. For example, in response to receiving a user input selecting a content segment, the displayed user interface is modified to display, in a first panel, a first selected one of the content segments and to concurrently display, in a second panel, retrieved aggregated information associated with a first entity of interest corresponding to the first selected content segment.

Although the above embodiments have been described in the context of method steps, they also represent a description of a corresponding component, module or feature of a corresponding apparatus or system.

Although the preferred embodiments of the present invention have been disclosed for illustrative purposes, those skilled in the art will appreciate that various modifications, additions and substitutions are possible, without departing from the scope of the invention as disclosed in the accompanying claims. In addition, those areas in which it is believed that those of ordinary skill in the art are familiar have not been described herein in order not to unnecessarily obscure the embodiments described herein. Accordingly, it is to be understood that the embodiments are not to be limited by the specific illustrative embodiments, but only by the scope of the appended claims. Some or all of the method steps may be implemented by a computer in that they are executed by (or using) a processor, a microprocessor, an electronic circuit or processing circuitry.

The embodiments described above may be implemented in hardware or in software. The implementation can be performed using a non-transitory storage medium such as a computer-readable storage medium, for example a floppy disc, a DVD, a Blu-Ray, a CD, a solid-state disk, a ROM, a PROM, and EPROM, an EEPROM or a FLASH memory. Such computer-readable media can be any available media that can be accessed by a general-purpose or special-purpose computer system.

Generally, embodiments can be implemented as a computer program product with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor. In a further embodiment, an apparatus comprises one or more processors and the storage medium mentioned above.

In a further embodiment, an apparatus comprises means, for example processing circuitry like e.g. a processor communicating with a memory, the means being configured to, or adapted to, perform one of the methods described herein.

A further embodiment comprises a computer having installed thereon the computer program or instructions for performing one of the methods described herein.

Note that any computer hardware/software architecture may be utilized to implement an embodiment of the present invention. The invention is not limited to implementation by the type of computer architecture illustrated and described. For example, other arrangements such as central mainframe/terminal architecture, client/server architecture or any other type of arrangement may be utilized to implement the present invention. In one arrangement, a plurality of network computers may be utilized to enable, for example, a plurality of users to access the system from their own computer terminals. The network may be any network (which may be wireless and/or wired), the Internet for example.

More precisely the electronic project assistance system 110 and associated method 1300 described above may be performed at one or more servers. The one or more data sources 160 may be servers having any suitable server architecture. Additionally or alternatively, the electronic project assistance system 110 and associated method 1300 may be implemented at least in part at user devices.

Each of the user devices may include one or more processors and these can be implemented as a single processor or multiple processors working together or independently to execute processor executable instructions stored on the non-transitory computer readable medium to implement the functionality described herein. Embodiments of the processor may include a digital signal processor (DSP), a central processing unit (CPU), a microprocessor, a multi-core processor, an application specific integrated circuit, and combinations thereof. The non-transitory computer readable medium can be implemented as RAM, ROM, flash memory or the like, and may take the form of a magnetic device, optical device or the like. The non-transitory computer readable medium can be a single non-transitory computer readable medium, or multiple non-transitory computer readable medium functioning logically together or independently. The digital project assistance system 20 may also include one or more processors, and one or more non-transitory computer readable mediums, linked by way of high-speed bus. The processor and the non- transitory computer readable medium of the project system may be implemented in a similar manner as the processor and the non-transitory computer readable medium discussed above with respect to the user devices. In a different arrangement a notebook computer, tablet computer, eBook reader device, a smart phone device, smart glasses, virtual reality, augmented reality device or any similar device can be used simultaneous and/or individually by one or more users.

The following is a list of embodiments of the invention:

Embodiment 1: A computer-implemented method of facilitating processing of project data, comprising: receiving an electronic project document comprising one or more content segments, wherein the electronic project document is associated with one or more document sources; analyzing the one or more content segments to identify entities of interest comprised in the one or more content segments; retrieving, from a data source, aggregated information associated with one or more of the identified entities of interest and the one or more document sources; receiving a user input selecting at least a first content segment of the one or more content segments; and in response to receiving the user input, modifying a displayed user interface to display, in a first panel, the selected first content segment and to concurrently display, in a second panel, retrieved aggregated information associated with at least a first entity of interest comprised in the selected first content segment.

Embodiment 2: The computer-implemented method of embodiment 1, wherein displaying the user interface further comprises displaying, in a third panel, at least one content segment of another electronic project document associated with the first entity of interest and associated with at least one document source of the one or more document sources.

Embodiment 3: The computer-implemented method of embodiment 1 or 2, wherein displaying, in the second panel, the retrieved aggregated information comprises displaying an indication of a current state of a project associated with the electronic project document with respect to the first entity of interest comprised in the selected first content segment and an indication of at least one predicted future state of the project with respect to the first entity of interest comprised in the selected first content segment, wherein the indication of the at least one predicted future state of the project is based on analysis of other electronic project documents associated with at least one document source of the one or more document sources.

Embodiment 4: The computer-implemented method of embodiment 3, wherein displaying, in the second panel, the retrieved aggregated information comprises displaying a timeline user interface element, wherein the timeline user interface element displays the indication of the current state of the project and the indication of at least one predicted future state of the project in a chronological order.

Embodiment 5: The computer-implemented method of embodiment 3 or 4, wherein the electronic project document is associated with a patent application and the first entity of interest is an objection, wherein the at least one predicted future state of the project corresponds to a project rejection score, the project rejection score being associated with a likelihood of obtaining a patent, and wherein, if the project rejection score is above a predetermined threshold value, the method further comprises displaying, in the user interface, a graphical risk warning icon.

Embodiment 6: The computer-implemented method of one of the preceding embodiments, wherein the retrieved aggregated information displayed in the second panel is associated with the first entity of interest and a first one of the one or more document sources, and wherein the method further comprises, in response to receiving a user input, modifying the displayed user interface to display, in the second panel, the retrieved aggregated information associated with the first entity of interest and a second one of the one or more document sources.

Embodiment 7: The computer-implemented method of one of the preceding embodiments, wherein the analyzing the one or more content segments to identify entities of interest comprised in the one or more content segments is performed in response to receiving the user input selecting the first content segment of the one or more content segments.

Embodiment 8: The computer-implemented method of one of embodiments 1 to 6, wherein the analyzing the one or more content segments to identify entities of interest comprised in the one or more content segments is performed in response to receiving the electronic project document.

Embodiment 9: The computer-implemented method of one of the preceding embodiments, further comprising: processing the identified entities of interest to generate the aggregated information; and storing the identified entities of interest and the aggregated information in one or more data sources.

Embodiment 10: The computer-implemented method of one of the preceding embodiments, wherein the one or more document sources comprise a project participant and a group of individuals comprising the project participant.

Embodiment 11: The computer-implemented method of one of the preceding embodiments, wherein the project participant is an author of the electronic project document or a recipient of the electronic project document.

Embodiment 12: The computer-implemented method of one of the preceding embodiments, wherein the identified entities of interest comprise one or more of a name of a project participant, a name of a project, a name of a product, a reference to a technical concept, a reference to a legal concept, a reference to a legal article, an objection, a reference to a document and a reference to a case law decision.

Embodiment 13: The computer-implemented method of one of the preceding embodiments, wherein the aggregated information comprises at least one of statistical data, performance metrics, trend data and multiple documents.

Embodiment 14: The computer-implemented method of one of the preceding embodiments, further comprising: in response to receiving a selection of at least one of the first panel and the second panel, generating a collaboration project space comprising the selected at least one panel; identifying at least one collaborator based on the retrieved aggregated information associated with at least one entity of interest corresponding to the first selected content segment, wherein the at least one collaborator is, prior to the selection, not a project participant; and providing the at least one collaborator with access to the collaboration project space.

Embodiment 15: The computer-implemented method of one of the preceding embodiments, further comprising: determining a project complexity score based on one or more of a type of the identified entities of interest, a status of the identified entities of interest, the one or more document sources and the retrieved aggregated information.

Embodiment 16: The computer-implemented method of embodiment 15, wherein the method further comprises, if the project complexity score is above a predetermined threshold value, displaying, in the user interface, a graphical warning icon.

Embodiment 17: The computer-implemented method of one of the preceding embodiments, wherein the electronic project document is associated with a patent application and the first entity of interest comprised in the first selected content segment is an objection, and wherein the method further comprises: determining a type of the objection; determining a status of the objection, wherein the status is one of new, maintained, overcome and other; and determining an objection intensity score for the objection based at least in part on the determined type and/or the determined status.

Embodiment 18: The computer-implemented method of embodiment 17, wherein the method further comprises, if the objection intensity score is above a predetermined threshold value, displaying, in the user interface, a graphical warning icon.

Embodiment 19: The computer-implemented method of one of embodiments 15 to 20, wherein the user interface is further configured to display a list of projects, wherein the list of projects includes a project associated with the electronic project document, and wherein an order of the projects in the list of projects is based at least in part on an upcoming due date associated with each of the projects in the list of projects and at least one of the project complexity score and the objection intensity score.

Embodiment 20: The computer-implemented method of one of the preceding embodiments, further comprising: in response to detecting a user interaction with the first panel, modifying the displayed user interface to display, in the first panel, the first entity of interest comprised in the selected first content segment and a second entity of interest comprised in the selected first content segment, and to concurrently display, in the second panel, retrieved aggregated information associated with both the first entity of interest and the second entity of interest.

Embodiment 21: The computer-implemented method of one of the preceding embodiments, further comprising: receiving a user input selecting a second content segment of the one or more content segments; and in response to receiving the user input, modifying the displayed user interface to display, in the first panel, the selected first content segment and the selected second content segment, and to concurrently display, in the second panel, retrieved aggregated information associated with both the first entity of interest comprised in the selected first selected content segment and a first entity of interest comprised in the selected second content segment.

Embodiment 22: The computer-implemented method of one of embodiments 3 to 21, further comprising at least one of: modifying the indication of the current state of the project to display an indication of the current state of the project with respect to both the first entity of interest comprised in the selected first content segment and a first entity of interest comprised in a selected second content segment, and modifying the indication of the at least one predicted future state of the project to display the at least one predicted future state of the project with respect to both the first entity of interest comprised in the first selected content segment and a first entity of interest comprised in a selected second content segment.

Embodiment 23: The computer-implemented method of embodiment 22, wherein the at least one of modifying the indication of the current state of the project and modifying the indication of the at least one predicted future state of the project is performed in response to receiving a user input selecting the second content segment.

Embodiment 24: A computer-readable storage medium having computer-executable instructions stored thereon which, when executed by the processor, perform the method of one of embodiments 1 to 23.

Embodiment 25: A computing system for facilitating processing of project data, comprising: a display device configured to display a user interface; a processor; and a memory having computer-executable instructions stored thereon which, when executed by the processor, cause the computing display system to perform operations comprising: display an electronic project document comprising one or more content segments, wherein the electronic project document is associated with one or more document sources; in response to receiving user input selecting at least a first content segment of the one or more content segments, display a first user interface panel comprising the selected first content segment and concurrently display a second user interface panel comprising representations of retrieved aggregated information associated with the one or more document sources and at least a first entity of interest comprised in the selected first content segment.

Embodiment 26: The system of embodiment 25, wherein the operations further comprise: in response to receiving the user input selecting the at least first content segment of the one or more content segments, displaying a third user interface panel comprising at least one content segment of another electronic project document associated with the first entity of interest and associated with at least one document source of the one or more document sources.

Embodiment 27: The system of embodiment 25 or 26, wherein displaying the second user interface panel comprises displaying an indication of a current state of a project associated with the electronic project document with respect to the first entity of interest and an indication of at least one predicted future state of the project with respect to the first entity of interest, wherein the indication of the at least one predicted future state of the project is based on analysis of other electronic project documents associated with at least one document source of the one or more document sources.

Embodiment 28: The system of embodiment 27, wherein displaying, in the second user interface panel, the retrieved aggregated information corresponding to the selected first content segment further comprises displaying a timeline user interface element, wherein the timeline user interface element displays the indication of the current state of the project and the indication of the at least one predicted future state of the project in a chronological order.

Embodiment 29: The system of embodiment 27 or 28, wherein the electronic project document is associated with a patent application and the first entity of interest is an objection, wherein the at least one predicted future state of the project corresponds to a project rejection score, the project rejection score being associated with a likelihood of obtaining a patent, and wherein, if the project rejection score is above a predetermined threshold value, the operations further comprise displaying, in the user interface, a graphical risk warning icon.

Embodiment 30: The system of one of embodiments 25 to 29, wherein the retrieved aggregated information comprised in the second user interface panel is associated with the first entity of interest and a first one of the one or more document sources, and wherein the operations further comprise, in response to receiving a user input, modifying the displayed user interface panel to comprise the retrieved aggregated information associated with the first entity of interest and a second one of the one or more document sources.

Embodiment 31: The system of one of embodiments 25 to 30, wherein the operations further comprise: in response to receiving the user input selecting the first content segment, analyzing the first content segment to identify entities of interest comprised in the first content segment.

Embodiment 32: The system of one of embodiments 25 to 30, wherein the operations further comprise: in response to receiving the electronic project document, analyzing the one or more content segments to identify entities of interest comprised in the one or more content segments.

Embodiment 33: The system of embodiment 32, wherein the operations further comprise: processing the identified entities of interest to generate the aggregated information; and storing the one or more identified entities of interest and the aggregated information in one or more data sources.

Embodiment 34: The system of one of embodiments 25 to 33, wherein the one or more document sources comprise a project participant and a group of individuals comprising the project participant.

Embodiment 35: The system of one of embodiment 34, wherein the project participant is an author of the electronic project document or a recipient of the electronic project document.

Embodiment 36: The system of one of embodiments 25 to 35, wherein the identified entities of interest comprise one or more of a name of a project participant, a name of a project, a name of a product, a reference to a technical concept, a reference to a legal concept, a reference to legal article, an objection, a reference to a document and a reference to a case law decision.

Embodiment 37: The system of one of embodiments 25 to 36, wherein the aggregated information comprises at least one of statistical data, performance metrics, trend data and multiple documents.

Embodiment 38: The system of one of embodiments 25 to 37, wherein the operations further comprise: in response to receiving a selection of at least one of the first user interface panel and the second user interface panel, displaying a collaboration project space comprising the selected at least one panel; identifying at least one collaborator based on the retrieved aggregated information, wherein the at least one collaborator is, prior to the selection, not a project participant; and providing the at least one collaborator with access to the collaboration project space.

Embodiment 39: The system of one of embodiments 25 to 38, wherein the operations further comprise: determining a project complexity score based on one or more of a type of the identified entities of interest, a status of the identified entities of interest, the document source and the retrieved aggregated information.

Embodiment 40: The system of embodiment 39, wherein the operations further comprise: if the project complexity score is above a predetermined threshold value, displaying, in the user interface, a graphical warning icon.

Embodiment 41: The system of one of embodiments 25 to 41, wherein the electronic project document is associated with a patent application and the first entity of interest is an objection, and wherein the operations further comprise: determining a type of the objection; determining a status of the objection, wherein the status is one of new, maintained, overcome and other; and determining an objection intensity score for the objection based at least in part on the determined type and/or the determined status.

Embodiment 42: The system of embodiment 40, wherein the operations further comprise: if the objection intensity score is above a predetermined threshold value, displaying, in the user interface, a graphical warning icon.

Embodiment 43: The system of one of embodiments 38 to 42, wherein the operations further comprise: displaying a fourth user interface panel comprising a list of projects, wherein the list of projects includes a project associated with the at least one electronic project document, and wherein an order of the projects in the list of projects is based at least in part on an upcoming due date associated with each of the projects in the list of projects and at least one of the project complexity score and the objection intensity score.

Embodiment 44: The system of one of the preceding embodiments, wherein the operations further comprise: in response to detecting a user interaction with the first user interface panel, modifying the displayed first user interface panel to display the first entity of interest and a second entity of interest comprised in the first selected content segment, and the second user interface panel to concurrently display retrieved aggregated information associated with both the first entity of interest and the second entity of interest.

Embodiment 45: The system of one of embodiments 25 to 44, wherein the operations further comprise: receiving a user input selecting a second content segment of the one or more content segments; and in response to receiving the user input, modifying the displayed first user interface panel to display the selected content segment and modifying the displayed second user interface panel to display representations of retrieved aggregated information associated with the one or more document sources and a first entity of interest comprised in the selected second content segment.

Embodiment 46: The system of one of embodiments 25 to 45, wherein the operations further comprise: receiving a user input selecting at least a second content segment of the one or more content segments; and in response to receiving the user input, modifying the displayed first user interface panel to display the selected first content segment and the selected second content segment; and modifying the displayed second user interface panel to display representations of retrieved aggregated information associated with one or more document sources, the first entity of interest comprised in the first selected content segment, and a first entity of interest comprised in the second selected content segment.

Embodiment 47: The system of embodiment 46, wherein displaying the modified second user interface panel comprises displaying one or more of: an indication of the current state of the project with respect to both the first entity of interest comprised in the selected first content segment and the first entity of interest comprised in the selected second content segment and an indication of at least one predicted future state of the project with respect to both the first entity of interest comprised in the selected first content segment and the first entity of interest comprised in the selected second content segment.

What is claimed is:

1. A computer-implemented method of facilitating processing of project data, comprising:
receiving an electronic project document comprising one or more content segments, wherein the electronic project document is associated with one or more document sources;
analyzing the one or more content segments to identify entities of interest comprised in the one or more content segments;
retrieving, from a data source, aggregated information associated with one or more of the identified entities of interest and the one or more document sources;
receiving a user input selecting at least a first content segment of the one or more content segments; and
in response to receiving the user input, modifying a displayed user interface to display, in a first panel, the selected first content segment and to concurrently display, in a second panel, retrieved aggregated information associated with at least a first entity of interest comprised in the selected first content segment.

2. The computer-implemented method of claim 1, wherein displaying, in the second panel, the retrieved aggregated information comprises displaying an indication of a current state of a project associated with the electronic project document with respect to the first entity of interest and an indication of at least one predicted future state of the project with respect to the first entity of interest, wherein the indication of the at least one predicted future state of the project is based on analysis of other electronic project documents associated with at least one document source of the one or more document sources.

3. The computer-implemented method of claim 1, wherein the retrieved aggregated information displayed in the second panel is associated with the first entity of interest and a first one of the one or more document sources, and wherein the method further comprises, in response to receiving a user input, modifying the displayed user interface to display, in the second panel, the retrieved aggregated information associated with the first entity of interest and a second one of the one or more document sources.

4. The computer-implemented method of claim 2, further comprising at least one of: modifying the indication of the current state of the project to display an indication of the current state of the project with respect to both the first entity of interest comprised in the selected first content segment and a first entity of interest comprised in a selected second content segment, and modifying the indication of the at least one predicted future state of the project to display the at least one predicted future state of the project with respect to both the first entity of interest comprised in the selected first content segment and the first entity of interest comprised in the selected second content segment.

5. The computer-implemented method of claim 1, wherein analyzing the one or more content segments to identify entities of interest comprised in the one or more content segments comprises, in response to receiving the user input selecting the first one of the one or more content segments, analyzing the first one of the one or more content segments.

6. The computer-implemented method of claim 1, further comprising:
determining an objection intensity score based on one or more of a type of the identified entities of interest and a status of the identified entities of interest; and
determining a project complexity score based on two or more of a type of the identified entities of interest, a status of the identified entities of interest, the document source and the retrieved aggregated information.

7. The computer-implemented method of claim 1, wherein the one or more document sources comprise a project participant and a group of individuals comprising the project participant.

8. The computer-implemented method of claim 1, further comprising:
in response to receiving a selection of at least one of the first panel and the second panel, displaying a collaboration project space comprising the selected at least one panel;
identifying at least one collaborator based on the retrieved aggregated information, wherein the at least one collaborator is, prior to the selection, not a project participant; and
providing the at least one collaborator with access to the collaboration project space.

9. A computer-readable storage medium having computer-executable instructions stored thereon which, when executed by the processor, perform the method of claim 1.

10. A computing system for facilitating processing of project data, comprising:
a display device configured to display a user interface;
a processor; and
a memory having computer-executable instructions stored thereon which, when executed by the processor, cause the computing display system to perform operations comprising:
display an electronic project document comprising one or more content segments, wherein the electronic project document is associated with one or more document sources; and
in response to receiving user input selecting at least a first content segment of the one or more content segments, display a first user interface panel comprising the selected first content segment and concurrently display a second user interface panel comprising representations of retrieved aggregated information associated with the one or more document sources and a first entity of interest comprised in the selected at least a first content segment.

11. The system of claim 10, wherein the retrieved aggregated information displayed in the second user interface panel is associated with the first entity of interest and a first one of the one or more document sources, and wherein the operations further comprise, in response to receiving a user input, modifying the displayed second user interface panel to display the retrieved aggregated information associated with the first entity of interest and a second one of the one or more document sources.

12. The system of claim 10, wherein the operations further comprise:
receiving a user input selecting at least a second content segment of the one or more content segments; and
in response to receiving the user input, at least one of: modifying the displayed first user interface panel to display the selected second content segment and modifying the displayed second user interface panel to display representations of retrieved aggregated information associated with the one or more document sources and a first entity of interest comprised in the selected second content segment.

13. The system of claim 10, wherein the operations further comprise:
receiving a user input selecting at least a second content segment of the one or more content segments; and
in response to receiving the user input, modifying the displayed first user interface panel to display the selected first content segment and the selected second content segment and modifying the displayed second user interface panel to display representations of retrieved aggregated information associated with the one or more document sources, the first entity of interest comprised in the selected first content segment, and a first entity of interest comprised in the selected second content segment.

14. The system of claim 10, wherein the operations further comprise: in response to receiving the electronic project document, analyzing the one or more content segments to identify corresponding entities of interest.

15. The system of claim 10, wherein the operations further comprise:
in response to receiving a selection of at least one of the first user interface panel and the second user interface panel, displaying a collaboration project space comprising the selected at least one panel;
identifying at least one collaborator based on the retrieved aggregated information, wherein the at least one collaborator is, prior to the selection, not a project participant; and
providing the at least one collaborator with access to the collaboration project space.
